(19) United States
(12) Patent Application Publication
(10) Pub. No.: US 2021/0353051 A1
(43) Pub. Date: Nov. 18, 2021

(54) SUPPORT DEVICES FOR HOLDING ITEMS AND METHODS OF MAKING AND USING THE SAME

(71) Applicant: PHIFER Incorporated, Tuscaloosa, AL (US)

(72) Inventors: Beverly Phifer, Tuscaloosa, AL (US); Timothy Wilson, Moundville, AL (US); Frank Wingard, Tuscaloosa, AL (US)

(21) Appl. No.: 17/323,969

(22) Filed: May 18, 2021

Related U.S. Application Data
(60) Provisional application No. 63/026,679, filed on May 18, 2020.
(60) Provisional application No. 63/112,527, filed on Nov. 11, 2020.

(51) Int. Cl. A47B 23/04; F16B 1/00; F16M 11/20

(52) U.S. Cl. CPC A47B 23/043; F16B 2001/0035; F16M 11/2021; F16B 1/00

(57) ABSTRACT

The disclosure is directed to support devices and methods of making and using the same. A support device of the disclosure may be provided to hold one or more items, such as an electronic device. The support device can include (a) a base assembly; (b) a stand assembly pivotally attached to the base by a hinge, and the stand assembly including a first rotation assembly; and (c) an engagement assembly that includes a second rotation assembly, and the second rotation assembly engaged with the first rotation assembly such that the engagement assembly is rotatably attached to and supported on the stand assembly; and (d) a removable platform assembly that is slidably and removably supported on the engagement assembly, and the removable platform assembly including an attachment element that is configured to attach to a user device.

### RELATED PATENT APPLICATIONS AND PRIORITY

This application claims priority to U.S. Provisional Patent Application 63/026,679 filed May 18, 2020 (Attorney Docket 9004-0009PR), the content of which is incorporated herein by reference in its entirety. This application claims priority to U.S. Provisional Patent Application 63/112,527 filed Nov. 11, 2020 (Attorney Docket 9004-0009PR2), the content of which is incorporated herein by reference in its entirety.

### BACKGROUND OF THE DISCLOSURE

The disclosure is directed to and relates to support devices to support a personal electronic device and/or to support other items and methods of making and using the same.

Various devices have been used in the past to support personal electronic devices, such as a cell phone, electronic tablet computer, personal digital assistant (PDA), note pad, and various other items, for example. However, known devices for supporting such items have deficiencies.

### BRIEF SUMMARY OF THE DISCLOSURE

The disclosure is directed to and relates to support devices and methods of making and using the same. A support device of the disclosure may be provided to hold one or more items, such as an electronic device. The support device can include (a) a base assembly; (b) a stand assembly pivotally attached to the base by a hinge, and the stand assembly including a first rotation assembly; and (c) an engagement assembly that includes a second rotation assembly, and the second rotation assembly engaged with the first rotation assembly such that the engagement assembly is rotatably attached to and supported on the stand assembly; and (d) a removable platform assembly that is slidably and removably supported on the engagement assembly, and the removable platform assembly including an attachment element that is configured to attach to a user device.

### BRIEF DESCRIPTION OF THE DRAWINGS

The present disclosure can be more fully understood by reading the following detailed description together with the accompanying drawings, in which like reference indicators are used to designate like or similar elements, and in which:

FIG. 1 is a perspective view showing a support device with user device, in accordance with principles of the disclosed subject matter.

FIG. 2 is a perspective view of the support device of FIG. 1 without user device, in accordance with principles of the disclosed subject matter.

FIG. 3 is a top view of a pin assembly 40 used in the hinge assembly 70, in accordance with principles of the disclosed subject matter.

FIG. 4 is a side view of the support device 10, in accordance with principles of the disclosed subject matter.

FIG. 5 is a back perspective view of the support device 10, in accordance with principles of the disclosed subject matter.

FIG. 6 is a front or top view of a stand assembly 50, in accordance with principles of the disclosed subject matter.

FIG. 7 is a back view of the stand assembly 50, in accordance with principles of the disclosed subject matter.

FIG. 8 is a side view of the stand assembly 50 in a closed position, in accordance with principles of the disclosed subject matter.

FIG. 9 is a front view of an engagement assembly 100, in accordance with principles of the disclosed subject matter.

FIG. 10 is a back view of an engagement assembly 100, in accordance with principles of the disclosed subject matter.

FIG. 11 is a top view of the base assembly 20, in accordance with principles of the disclosed subject matter.

FIG. 12 is a side view of the base assembly 20 in accordance with principles of the disclosed subject matter.

FIG. 13 is an end view of the base assembly 20, in accordance with principles of the disclosed subject matter.

FIG. 14 is a bottom view of the base assembly 20, in accordance with principles of the disclosed subject matter.

FIG. 15 is a front view of a sliding handle 142 that is a part of the engagement assembly 100, in accordance with principles of the disclosed subject matter.

FIG. 16 is a diagram showing a magnet 170, in accordance with principles of the disclosed subject matter.

FIG. 17 are multiple views of a prop body 91, in accordance with principles of the disclosed subject matter.

FIG. 18 is a perspective view showing a support device, in accordance with a further embodiment of the disclosure, with user device, in accordance with principles of the disclosed subject matter.

FIG. 19 is a perspective view of the support device 10′ of FIG. 18 without user device, in accordance with principles of the disclosed subject matter.

FIG. 20 is a side view of the support device 10′, in accordance with principles of the disclosed subject matter.

FIG. 21 is a back perspective view of the support device 10′, in accordance with principles of the disclosed subject matter.

FIG. 22 is a front view of a stand assembly 50, in accordance with principles of the disclosed subject matter.

FIG. 23 is a back view of the stand assembly 50 of the support device 10′, in accordance with principles of the disclosed subject matter.

FIG. 24 is a side view of the stand assembly 50 of the support device 10′ in a closed position, in accordance with principles of the disclosed subject matter.

FIG. 24B is a further side view of the stand assembly 50 of the support device 10′ in a closed position, showing further details in phantom, in accordance with principles of the disclosed subject matter.

FIG. 25 is a front view of an engagement assembly 300 of the support device 10′ of FIGS. 18 and 19, in accordance with principles of the disclosed subject matter.

FIG. 26 is a back view of an engagement assembly 300, in accordance with principles of the disclosed subject matter.

FIG. 26B is a cross-section diagram along line 26B of FIG. 26, showing further details of the body portion 301 of the engagement assembly 300, in accordance with principles of the disclosed subject matter.

FIG. 27 is a top view of the base assembly 20, in accordance with principles of the disclosed subject matter.

FIG. 28 is a side view of the base assembly 20 in accordance with principles of the disclosed subject matter.

FIG. 29 is an end view of the base assembly 20, in accordance with principles of the disclosed subject matter.

FIG. 30 is a bottom view of the base assembly 20, in accordance with principles of the disclosed subject matter.

FIG. 31 is a front view of a platform assembly 370 that is a part of the engagement assembly 300, in accordance with principles of the disclosed subject matter.

FIG. 32 is a back view of a platform assembly 370 of FIG. 31, in accordance with principles of the disclosed subject matter.

FIG. 33 is a diagram showing an attachment plate 390, in accordance with principles of the disclosed subject matter.

FIG. 34 are multiple views of a sliding prop member 90, in accordance with principles of the disclosed subject matter.

FIG. 35 is a perspective view of a washer and screw arrangement that is a component of the support device 10′, in accordance with principles of the disclosed subject matter.

FIG. 36 is a partial view of handle 142 with pin 147, in accordance with principles of the disclosed subject matter.

FIG. 37 is a top perspective view showing a support device, in accordance with a further embodiment, in accordance with principles of the disclosed subject matter.

FIG. 38 is a top perspective view of a support device showing a sliding relationship between the engagement assembly and the removable platform assembly.

FIG. 39 is a top perspective view of a support device with the removable platform assembly and slide desk omitted, in accordance with principles of the disclosed subject matter.

FIG. 40 is a perspective view of a removable platform assembly, in accordance with principles of the disclosed subject matter.

FIG. 41 is a back view of a removable platform assembly, in accordance with principles of the disclosed subject matter.

FIG. 42 is a top view of a removable platform assembly of a further embodiment, in accordance with principles of the disclosed subject matter.

FIG. 43 is a back view of the removable platform assembly of FIG. 42, in accordance with principles of the disclosed subject matter.

FIG. 44 is a perspective view of a support device, in accordance with principles of the disclosed subject matter.

FIG. 45 is a top perspective view showing a support device, in accordance with a further embodiment, in accordance with principles of the disclosed subject matter.

FIG. 46 is a top perspective view of the support device of FIG. 45 showing a sliding relationship between the engagement assembly and the removable platform assembly, in accordance with principles of the disclosed subject matter.

FIG. 47 is a back view of a removable platform assembly of the support device of FIG. 45, in accordance with principles of the disclosed subject matter.

FIG. 48 is a back perspective view of the support device 800 of FIG. 45 with a phone (user device) positioned upon the support device 800, in accordance with principles of the disclosed subject matter.

FIG. 49 is a front perspective view of the support device 800 of FIG. 45 supporting a user device for portrait viewing, in accordance with principles of the disclosed subject matter.

FIG. 50 is a front perspective view of the support device 800 of FIG. 45 supporting a user device for landscape viewing, in accordance with principles of the disclosed subject matter

### DETAILED DESCRIPTION OF THE DISCLOSURE

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

As used herein, any term in the singular may be interpreted to be in the plural, and alternatively, any term in the plural may be interpreted to be in the singular.

The disclosure provides support devices and methods of making and using the same. The support devices described may be used to hold a wide variety of personal electronic devices such as an electronic tablet computer, cell phone, personal digital assistant (PDA), land phone, smart phone, car phone, computer terminal, texting device, satellite radio device, voice over IP device, and/or any other mobile user device as well as other items, such as books, recipes or other documents, for example.

The support device of this disclosure can hold one or more items. In particular, the support device is provided to hold a cell phone and allow for various manipulation of the cell phone as supported upon the support device. In particular, the support device provides for angular positioning of a cell phone held thereupon, as well as provides for rotational manipulation of a cell phone held on the support device. Such rotational manipulation provides for portrait viewing of a cell phone or landscape viewing of a cell phone, as may be desired. The support device of the disclosure provides a variety of manipulation capabilities, which (among other features) distinguish the support device of the disclosure over known devices.

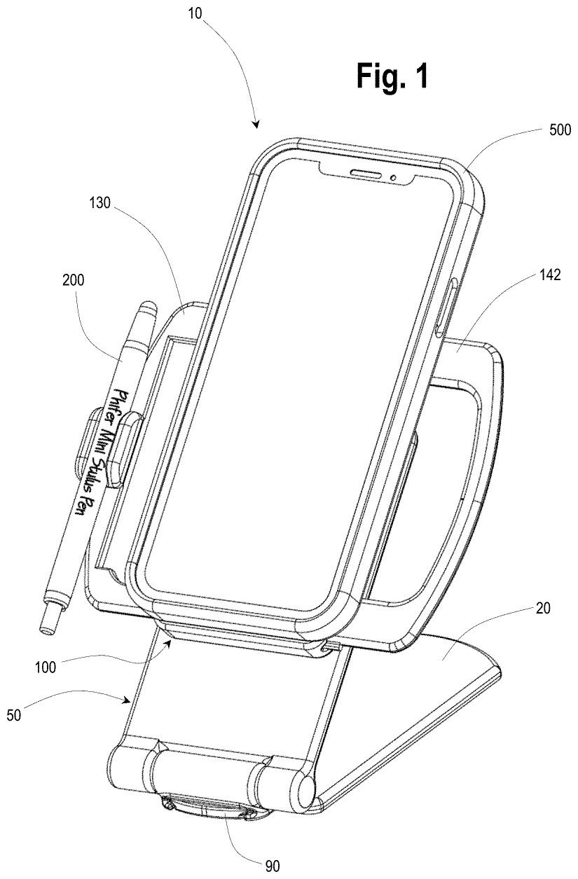

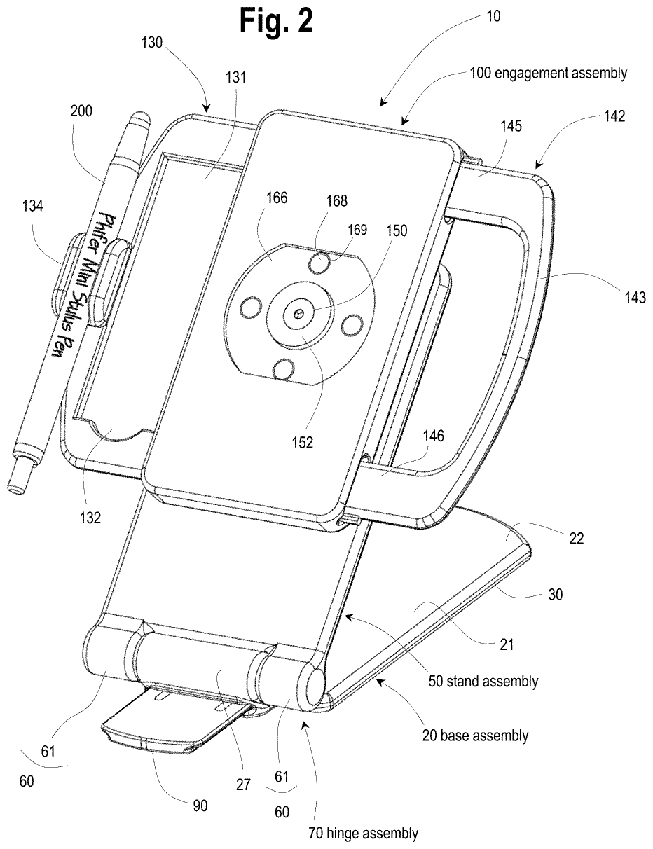

FIG. 1 is a perspective view showing a support device 10 with user device, in accordance with principles of the disclosed subject matter. FIG. 2 is a perspective view of the support device of FIG. 1 without user device, in accordance with principles of the disclosed subject matter. The support device 10 can include a base assembly 20, a stand assembly 50, and an engagement assembly 100. The stand assembly 50 can be hingedly or pivotally attached to the base assembly 20 as described below. The base assembly 20 can include a base body portion 21. The base body portion 21 can include a top face 22 and a bottom face 30. The stand assembly 50 can be rotatably mounted upon the base assembly 20. For example, the stand assembly 50 can be rotatably mounted so as to adjust an angle of the base assembly 20. The engagement assembly 100 can be mounted upon the stand assembly 50. In particular, the engagement assembly 100 can be rotatably mounted upon the stand assembly 50. A user device, such as a cell phone, can be attached to the engagement assembly 100. For example, the engagement assembly 100 can include one or more magnets that engage with a magnet that is affixed to a cell phone. The engagement assembly 100 can include a front face 110 and a back face 120. The engagement assembly 100 can include a body portion 101. Various structure can be attached to the body portion 101. Further details are described below.

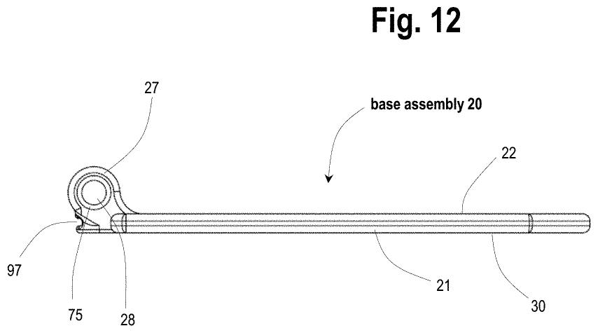

The base assembly 20 can include a hinge barrel 27. The hinge barrel 27 can constitute a center hinge portion so as to hingedly or pivotally support the stand assembly 50 upon the base assembly 20. The hinge barrel 27 can be part of a hinge assembly 70. The hinge barrel 27 can encompass or enclose a standoff 75. The standoff 75 can be a female threaded standoff 75. The hinge barrel 27 can include a hinge pin hole or bore 28. The hinge pin bore 28 can pass through a horizontal extent or length of the hinge barrel 27. The hinge barrel 27 and base body portion 21 are shown in FIG. 12. That is, FIG. 12 is a side view of the base assembly 20 in accordance with principles of the disclosed subject matter.

The base assembly 20 can include the bottom face 30. The bottom face 30 can be flat so as to stably support the support device 10 on a surface, such as a surface of a desk, for example. The bottom face 30 can include or be provided with a metal plate, pad and/or nonslip material 32. The plate 32, if constructed of metal, can provide attachment capability of the support device 10 to a magnet. The plate 32 can itself be magnetized so as to provide attachment to other metal. The plate 32, if constructed of non-slip material, can provide a cushioned and/or slip resistant surface. The plate 32 can be constructed of a metal plate that is encased in rubber, for example. The plate or pad 32 can be constructed of silicone strips for sliding resistance when on smooth surfaces. The bottom face 30 can be provided with openings, cavities, or slots so as to retain devices and/or so as to offer mounting capability to other structure or surfaces. The base assembly 20 can also be provided with a sliding prop member 90.

The stand assembly 50, as shown in FIGS. 1 and 2 can include a stand body portion 51. The stand body portion 51 can include or constitute a central or core portion of the stand assembly 50. The stand body portion 51 can include a top face 52 and a bottom face 53.

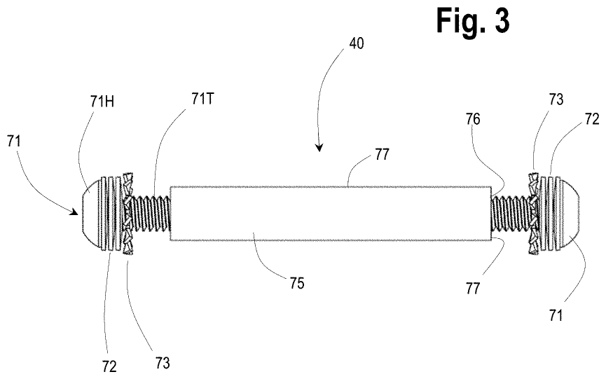

The stand assembly 50 can include hinge structure so as to hingedly, pivotally, or pivotably attach to the base assembly 20. The stand assembly 50 can include a hinge barrel assembly 60 as shown in FIG. 2. The hinge barrel assembly 60 can include opposing hinge barrels 61. Each of the hinge barrels 61 can include hinge pin holes or bores 62. Each of the hinge barrels 61 can be provided with a counterbore 64 as shown in FIG. 3. Each of the counterbores 64 can house a pin, threaded pin, screw or bolt 71.

A hinge assembly 70 can include the hinge barrel 27 and the hinge barrel assembly 60. The hinge assembly 70 can also include various other components that can be provided so as to attach the hinge barrel 27 to the hinge barrel assembly 60 (with the opposing hinge barrels 61).

FIG. 3 is a top view of a pin assembly 40 used in the hinge assembly 70, in accordance with principles of the disclosed subject matter.

As shown in FIGS. 2 and 3, the standoff 75 can be in the form of a female, internally threaded standoff that includes opposing threaded bores 76 that extend in from each end surface 78 of the standoff 75. The threaded bores 76 can respectively receive opposing pins 71 as shown in FIG. 3. The standoff 75 can be provided with an outer surface 77. The outer surface 77 of the standoff 75 can interface with or be enclosed by an inner surface of the hinge pin bore 28 through which the standoff 75 extends. The standoff 75 can be frictionally retained within the hinge pin bore 28.

The pins 71 of the hinge assembly 70 can be threaded pins 71. On both sides, a threaded pin 71 can pass through the hinge barrel 61, i.e. through the bore 62 that is associated with the counterbore 64, and be threaded into the standoff 75. Accordingly, each hinge barrel 61 can be “sandwiched” between a head 71H of the pin 71 and an end surface 78 of the standoff 75. The washers 72, 73 can assist in maintaining the threaded pin 71 in a fastened or tightened disposition. In at least one embodiment, the standoff 75 can be affixed to the opposing hinge barrels 61 due to tightening of the pins 71. Accordingly, a static disposition can be provided of the standoff 75 relative to the opposing hinge barrels 61. With such arrangement, the hinge barrel 27, of the base assembly 20, can be rotatable about the standoff 75. A friction relationship or fit between the standoff 75 and the hinge barrel 27 can both provide rotation and prevent undue rotation, i.e. until some predetermined force is applied by a user. Accordingly, the friction fit can allow a user to position the stand assembly 50 relative to the base assembly 20 at a desired angle, until the user applies pressure to manipulate the support device 10 so as to change the arrangement.

As shown in FIG. 3, the hinge pin assembly 40 can include the standoff 75, the pin 71, and washers 72, 73. The washer 72 can include a spring lock washer, a steel Belleville disc spring washer, or other similar washer. The washer 73 can include a lock washer, and external tooth lock washer, or other similar washer. The pin 71 can be a threaded-locking button-head socket Screw, for example. Other screws and/or washers can be utilized as desired.

The stand assembly 50 can be provided with an attachment assembly 80, which can be described as a rotation assembly or as a first rotation assembly 80. The attachment assembly 80 can include a raised center platform 82. The raised center platform 82 can engage with or mate with a mating attachment recess 162 (of an attachment assembly 160) on a back surface of the engagement assembly 100. The attachment assembly 160 can be described as a rotation assembly or as a second rotation assembly 160. Accordingly, the raised portion 82 can be provided on the stand assembly 50 that engages or mates with a recessed portion of the engagement assembly 100. Such structure could be reversed such that the stand assembly 50 includes a recessed portion and the engagement assembly 100 includes the raised portion. In general, the various engagement surfaces, as described herein, including raised portions that engage with the recessed portions may be reversed on the respective components, as may be desired.

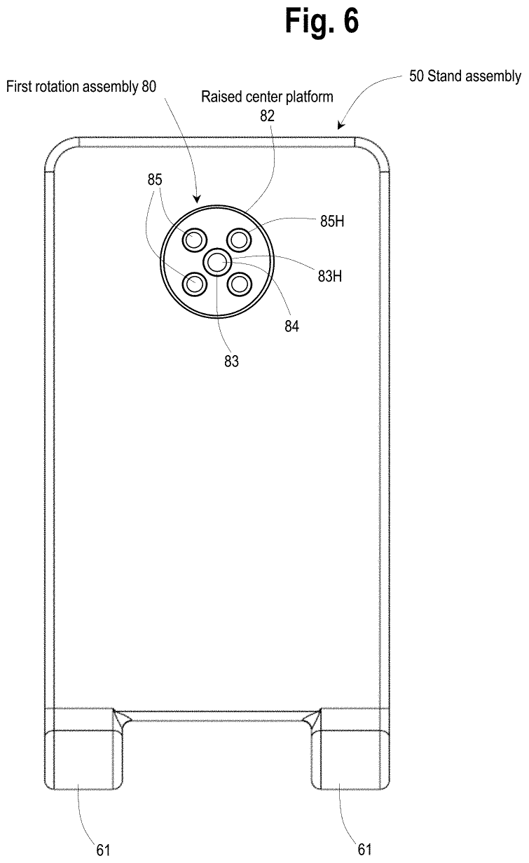

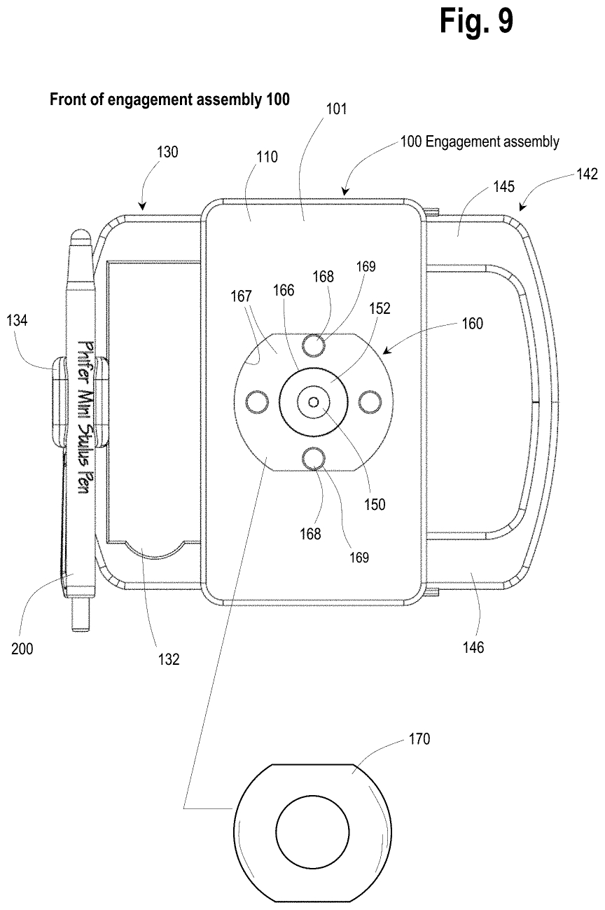

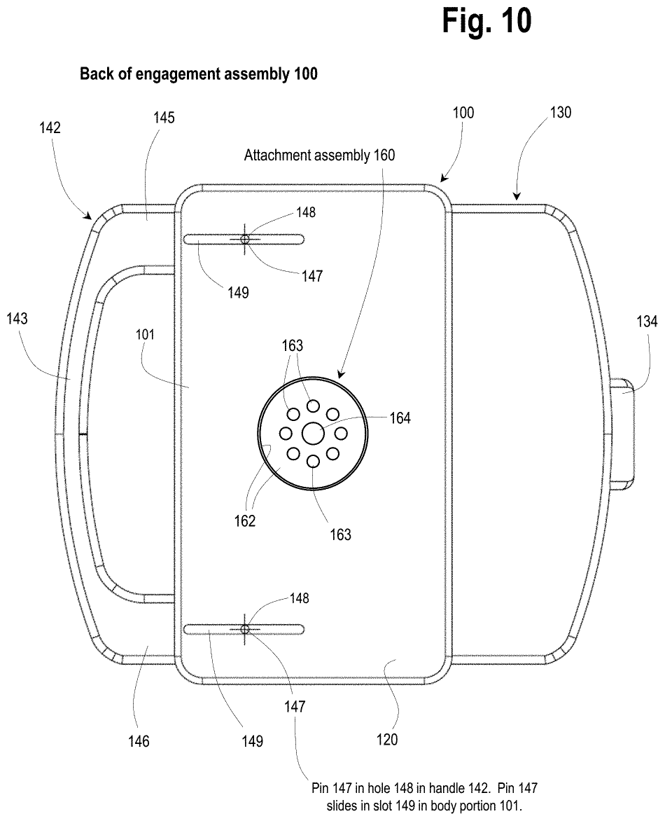

The raised center platform 82 can be provided with an opening, hole, or aperture in the center. An insert 83 with a threaded hole 84 can be disposed in such hole in the stand assembly 50. The insert 83 with threaded hole 84 can be integrated into the raised center platform 82 in the molding process of the component, in at least one embodiment of the disclosure. The insert 83 can be a heat set threaded insert. FIG. 6 is a top or front view of a stand assembly 50, in accordance with principles of the disclosed subject matter. FIG. 9 is a front view of an engagement assembly 100, in accordance with principles of the disclosed subject matter. FIG. 10 is a back view of an engagement assembly 100, in accordance with principles of the disclosed subject matter.

As shown in FIG. 6, the raised center platform 82 can also include a plurality of ball plungers or protuberances 85 (in holes 85H) that are spaced upon the raised center platform 82. For example, there can be four ball plungers 85. The ball plungers 85 can engage with cavities, recesses or holes 163 (in the mating attachment recess 162 of the attachment assembly 160) in the engagement assembly 100, as shown in FIG. 10. Such arrangement can resist rotation, by a user, until a certain degree of rotational force is applied to the engagement assembly 100 relative to the holder assembly 100. Upon a sufficient application of force, the ball plungers 85 can “click” past the cavities 163. Each of the ball plungers 85 can then click into another respective cavity 163 so as to maintain the engagement assembly 100 in a desired rotational position.

As described above, the engagement assembly 100 can be rotatably mounted onto the stand assembly 50. Such rotation can be provided by the mating attachment recess 162 mated with the raised center platform 82, as well as a suitable fastener such as a screw or bolt 150, and other associated structure and components.

FIG. 9 is a front view of the engagement assembly 100, in accordance with principles of the disclosed subject matter. The support device 10 can include further structure to maintain the stand assembly 50 in connection with the engagement assembly 100. Accordingly, FIG. 9 shows further features of the attachment assembly 160 (of the engagement assembly 100).

The attachment assembly 160 can include a washer receiving recess 166. The washer receiving recess 166 can receive a chamfered washer 152. The screw 150 can extend through the chamfered washer 152, through the attachment hole 164, and be threadably inserted into the attachment hole or bore 84. The attachment hole 84 can be threaded so as to receive the screw 150. In this manner, the engagement assembly 100 can be rotatably secured onto and supported by the stand assembly 150.

The screw 150 can be provided with a nylon patch or other anti-loosening mechanism so as to maintain position of the screw 150 in the insert 83, i.e. in the attachment hole 84 of the insert. The insert can be frictionally held or bonded into a hole 83H. It should be appreciated that the screw 150 may be tightened as desired. If the screw 150 is tightened too much, such may preclude rotation of the engagement assembly 100 and/or inhibit operation.

As described above, the chamfered washer 152 can be received into the washer receiving recess 166. A head of the screw 150 can be received into a chamfer or countersink of the chamfered washer 152. The chamfered washer 152 can be constructed of nylon or metal, for example, so as to assist in rotation of the engagement assembly 100 upon the holder assembly 100.

As described above, the engagement assembly 100 can include a magnet receiving recess 167. For example, as shown in FIG. 2, the magnet receiving recess 167 can be in the form of a depression in the front face 110 of the engagement assembly 100. A plurality of magnets 168 can be disposed in holes 169 in the magnet receiving recess 167. For example, four magnets can be disposed in the recess 167. The magnets can be molded into the body portion 101 or inserted into apertures that are created in the body portion 101. The magnets 168 can be secured either by integrated molding and/or adhesive, for example. The magnets 168 and/or the magnet receiving recess 167 can provide an attachment element. The attachment element can serve to attach to a user device, such as a cell phone.

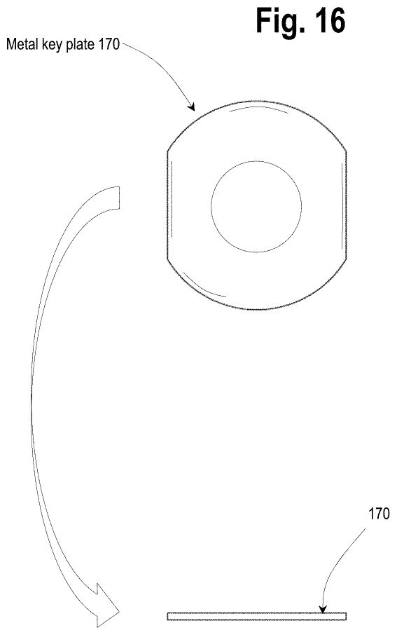

In further description, as shown in FIG. 9, a magnet 170 can be constructed of shape so as to fit into the magnet receiving recess 167. The magnet 170 can be described as a user device magnet or as a metal key plate, for example. The magnet 170 can be in the form of and/or include (a) a circle as an inner diameter and (b) a circle with opposing flat sides as an outer diameter, as shown in FIG. 9 as well as in FIG. 16.

That is, FIG. 16 is a diagram showing a magnet 170, in accordance with principles of the disclosed subject matter. The magnet 170 can include steel or other magnetic material that is magnetized so as to be attracted to the magnets 168. The magnet 170 can be seated within the magnet receiving recess 167. Additionally, the chamfered washer 152 can extend out of the washer receiving recess 166. Accordingly, the chamfered washer 152 can extend at least partially into an inner diameter of the magnet 170. Accordingly, such engagement between the chamfered washer 152 and the magnet 170 can serve to stably support the magnet 170 in the engagement assembly 100.

The magnet 170 can be attached to a user device, such as a cell phone. For example, Velcro pads with adhesive backing can be utilized. One Velcro pad can be adhesively attached to the magnet 170. A second Velcro pad can adhesively be attached to a cell phone. Then, by engaging the respective Velcro surfaces, the magnet 170 can be attached to the cell phone. Then, the magnet with cell phone can be inserted into the magnet receiving recess 167. Thus, the cell phone can be removably attached to the engagement assembly 100. Alternatively, the metal key plate or magnet 168 can be directly glued or adhesively attached to the backside of the user's phone. A user can manipulate the attached cell phone in any of a wide variety of ways as described herein. The user can rotate the cell phone utilizing the rotation assemblies 80, 160, for example. Also, the user can hold and manipulate the support device 10 with attached cell phone utilizing the sliding handle 142 and the extension assembly 130, for example.

Various other uses and manipulations can be performed with the support device 10. The chamfered washer 152 can be described as in the form of a finishing washer.

Rather than the magnet 170 and/or the magnets 68, other attachment mechanisms can be used to attach a phone or other item to the engagement assembly 100. For example, hook-and-loop (VELCRO) pads and/or adhesive can be used to attach a phone or other item to the engagement assembly 100.

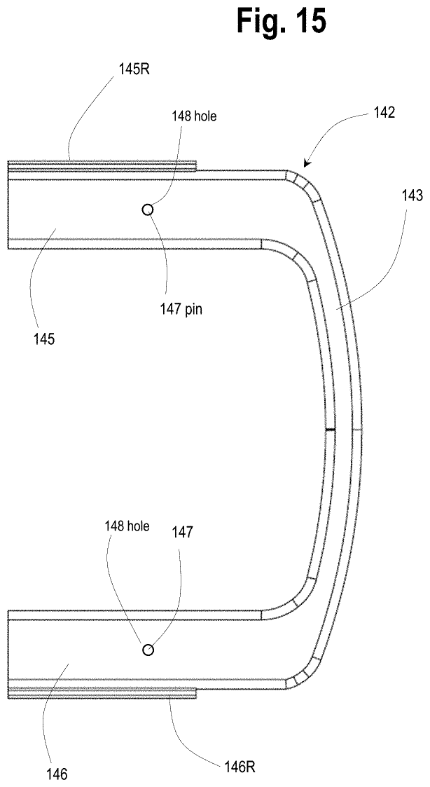

FIG. 15 is a front view of a sliding handle 142 that is a part of the engagement assembly 100, in accordance with principles of the disclosed subject matter. FIGS. 9 and 10 also show features of the sliding handle 142.

The engagement assembly 100 can include the sliding handle 142 so as to assist in manipulation of the support device 10, for example. The sliding handle 142 can be provided with structure so as to be slidable, to at least a limited degree, relative to the body portion 101. In other embodiments, a handle 122 can be provided that does not slide relative to the body portion 101, i.e. the engagement assembly 100 can include a static handle.

The sliding handle 142 can include a grip portion 143. The sliding handle 142 can include a top attachment prong 145. The sliding handle 142 can include a bottom attachment prong 146. The top and bottom attachment prongs 145, 146 can be received into respective slots or apertures of the body portion 101. Specifically, the top attachment prong 145 can be received into a handle receiving top slot 140. The bottom attachment prong 146 can be received into a handle receiving bottom slot 141.

With reference to FIGS. 10 and 15, the “travel” or amount that the handle 142 is allowed to slide back and forth relative to the body portion 101 can be constrained. For example, sliding handle 142 can include pins as shown in FIG. 15. The pins 142 can partially be secured in the prongs 145, 146 (in holes 148 in the respective prong) and extend outwardly from the prongs. The pins can extend outwardly so as to be received into slots 149. The pins 147 can be used to control “travel” distance of the handle 142 relative to the body portion 101. The pins 142 can travel within the slots 149 (in the body portion 101) wherein respective ends of such slots define a stop for the pins 147 to abut against. Accordingly, sliding movement of the handle 142 can be constrained or limited. From the front perspective of FIG. 9, the sliding handle 142 can be slid to the left into a retracted position against the body portion 101. In such retracted position or stowed position, the handle 142 can be of unobtrusive profile. On the other hand, the handle then can be slid to a fully extended position, i.e. slid to the right as shown in FIG. 9. In such fully extended position, the handle can be easily manipulated and fully grasped by a hand of the user. It should be appreciated that the variability of position of the handle 142 relative to the body portion 101 can be useful for other use scenarios.

As described above, the sliding handle or sliding pull handle 142 can be slidably disposed in the body portion 101. The engagement assembly 100 can include structure so as to assist in the sliding handle 142 smoothly sliding in and out of the body portion 101 without binding. For example, the slots 140, 141 can be provided with grooves that respectively engage with ribs or flanges that run along the prongs 145, 146. More specifically, the top attachment prong 145 can be provided with a rib or guide track 145R that is slidably received into a groove 140G with such groove running along the pull handle receiving slot 140. The bottom attachment prong 146 can be provided with a rib or guide track 146R that is slidably received into a groove 141G with such groove running along the pull handle receiving slot 141. It should be appreciated that such a structure could be reversed with the grooves positioned in the sliding handle 142 and the rib extending from an edge of one or both of the handle receiving slots 140, 141. It is appreciated that such arrangement, including the pins 147 engaged with slots 149, can provide a sliding handle 142 that can be moved by a user without binding, possesses sufficient frictional resistance so as to resist undesired movement, and provide structural integrity and strength so as to effectively be manipulated by a user.

The engagement assembly 100 can also include an extension assembly 130, as shown in FIG. 2. The extension assembly 130 can extend out from a side of the body portion 101. The extension assembly 130 can include a note cavity 131. The note cavity 131 can be configured and used to store a notepad. For example, the note cavity 131 can store a notepad comprising a plurality of note sheets that are adhesively stuck together. The note cavity 131 can store suitably sized POST-IT notes, for example. Such a notepad can be adhesively attached to the note cavity 131. The extension assembly 130 can also include an access groove 132. The access groove 132 can provide access to a user's finger so as to access a notepad in the note cavity 131. For example, a user might “peal” a sticky note from a notepad in the note cavity 131.

The extension assembly 130 can also include a retaining clip 134. The retaining clip can retain a writing instrument, stylus, pen, pencil, or other user device 200. The retaining clip 134 can include a pair of flexible shoulders that engage the user device.

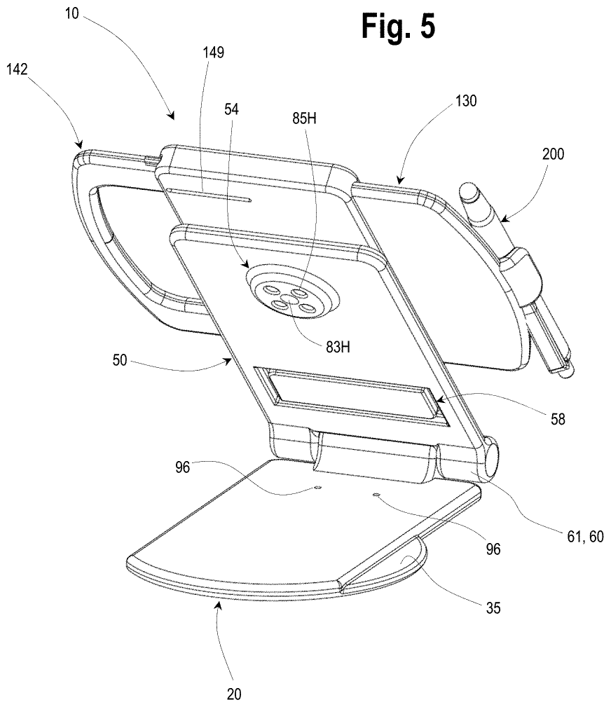

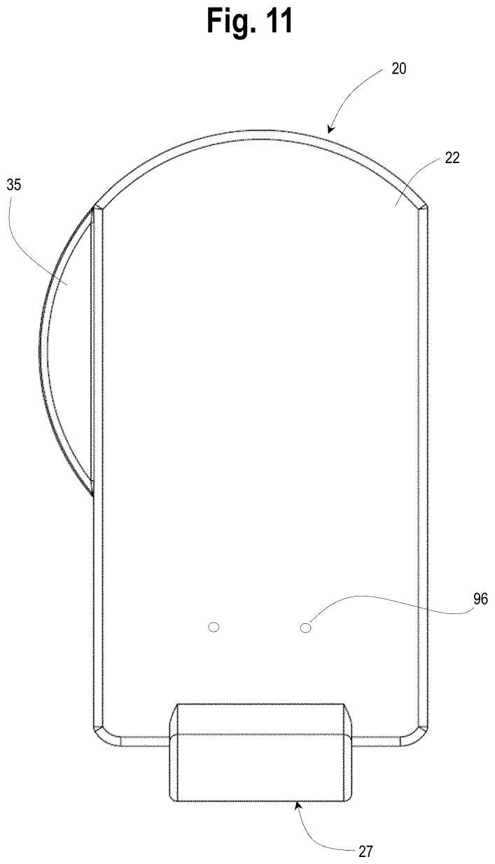

FIG. 5 is a back perspective view of the support device 10, in accordance with principles of the disclosed subject matter. FIG. 11 is a top view of the base assembly 20, in accordance with principles of the disclosed subject matter. As shown in FIGS. 5 and 11, the base assembly 20 can also include a side platform or tab 35. The tab 35 can assist a user in “opening” the support device 10 when in a closed position. That is, such closed position can be when the stand assembly 50 is fully rotated down, as shown in FIG. 5, so as to be in contact with the base assembly 20. Accordingly, in such arrangement, the stand assembly 50 can be substantially parallel to the base assembly 20.

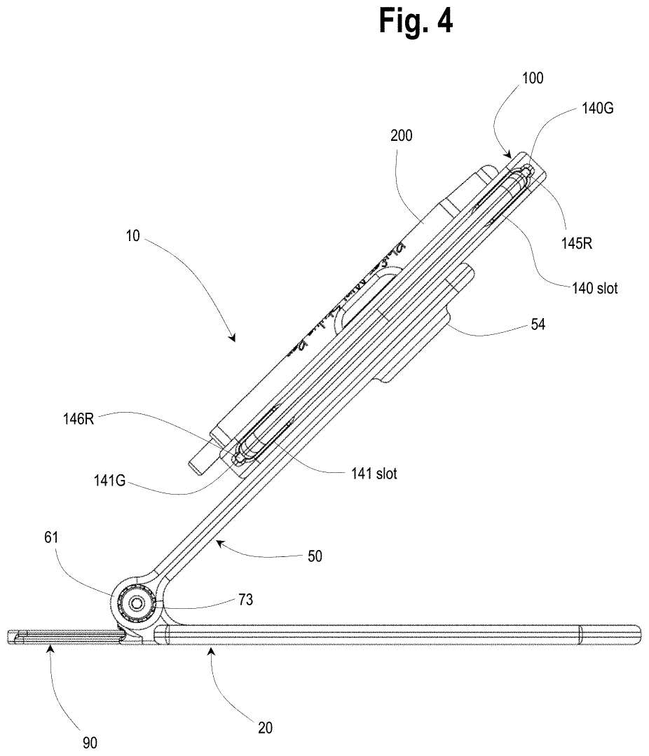

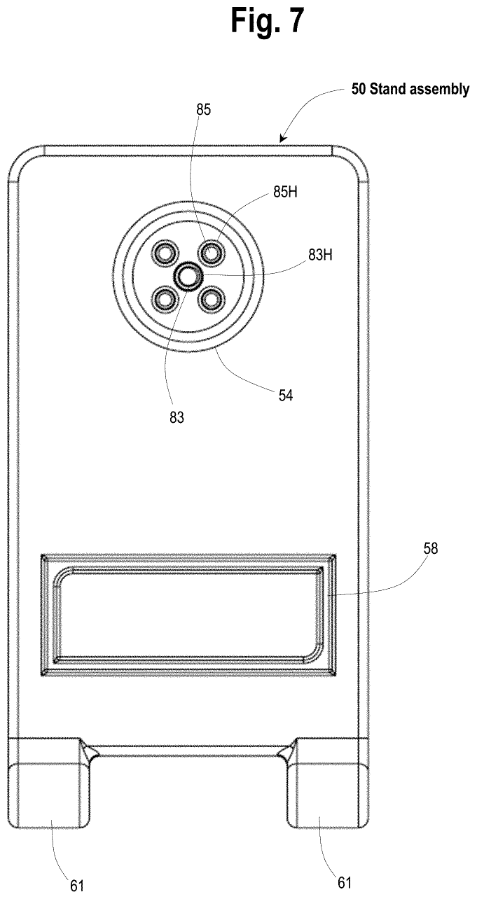

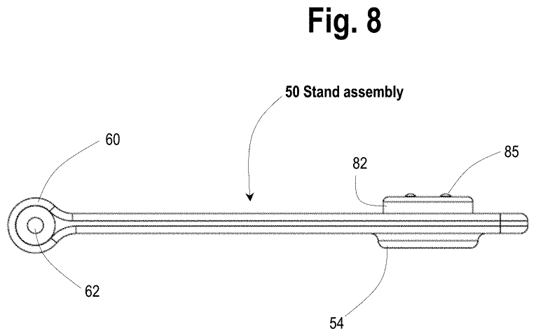

Relatedly, FIG. 5 also shows a platform stopping boss 54. FIG. 4 is a side view of the support device 10, in accordance with principles of the disclosed subject matter. FIG. 7 is a back view of the stand assembly 50, in accordance with principles of the disclosed subject matter. FIG. 8 is a side view of the stand assembly 50 in a closed position, in accordance with principles of the disclosed subject matter. FIGS. 4, 7 and 8 also show the platform stopping boss 54, as well as other features of the support device 10. The platform stopping boss 54 can extend from a bottom face 53 of the stand assembly 50. The platform stopping boss 54 can be circular in shape and can be in the form of a circular platform extending from the bottom face 53. The platform stopping boss 54 can extend an amount such that when the platform stopping boss 54 makes contact with the top face 22 of the base assembly 20, the base body portion 21 is parallel to the stand body portion 51. As shown in FIG. 5, the platform stopping boss 54 can include a center hole in which the insert 83 is position, as well as holes in which a respective ball plunger 85 is retained. That is, the hole for the insert 83 and surrounding holes for the ball plungers 85 can be “through holes” that extend through the entire thickness of the stand body portion 51. Such construct can be helpful in manufacturing of the support device 10.

The bottom face 53 of the stand assembly 50 can also include wrench grooves 58. The wrench grooves 58 can retain an Allen wrench, for example, that can be of suitable size to adjust the screw 150, as described above. For example, the wrench groove 58 can be in the form of a rectangle that is cut or etched or molded into the bottom face 53.

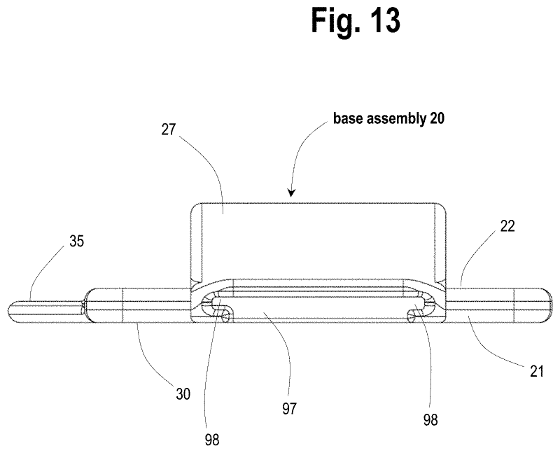

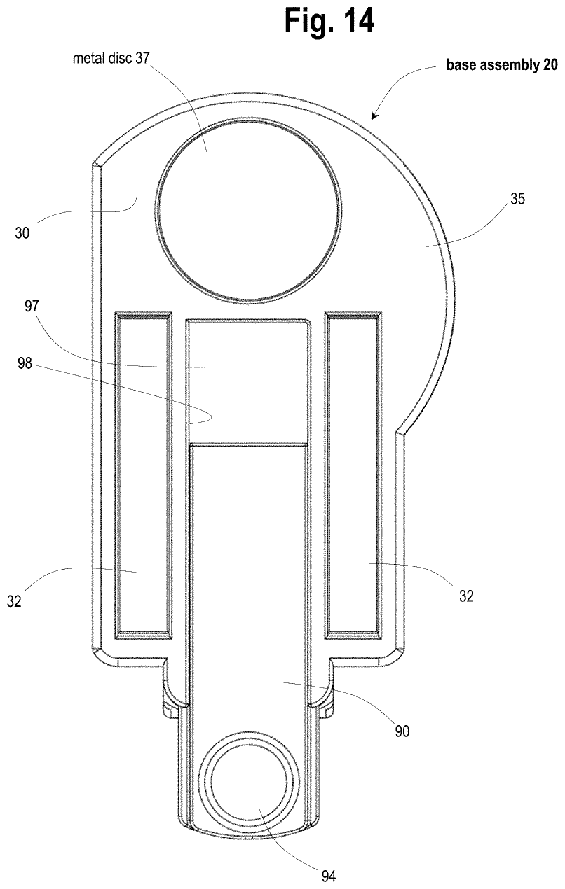

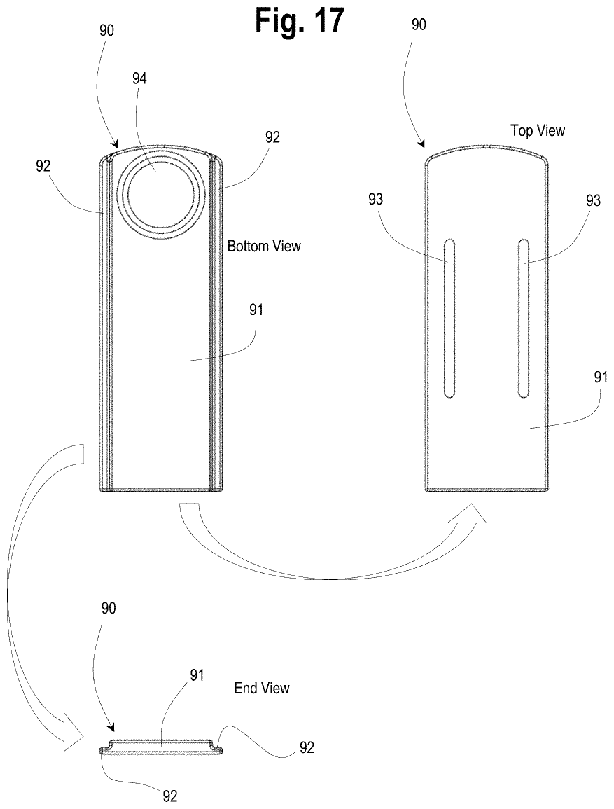

FIG. 5 also shows a pair of pins 96 in the base body portion 21 of the base assembly 20. The pins 96 can engage with a sliding prop member 90. Relatedly, FIG. 13 is an end view of the base assembly 20, in accordance with principles of the disclosed subject matter. FIG. 14 is a bottom view of the base assembly 20, in accordance with principles of the disclosed subject matter. Also, FIG. 17 are multiple views of a prop body 91, in accordance with principles of the disclosed subject matter.

As shown in FIGS. 13, 14, and 17, as well as FIG. 2, for example, the base assembly 20 can include a sliding prop member 90 the sliding prop member 90 can be selectively slid from an extended position to a retracted position. The retracted position is shown in FIG. 1, for example. The extended position is shown in FIG. 2, for example. In the extended position, the sliding prop member 90 can serve to support the support device 10 as well as providing stability and to resist tipping, for example. The sliding prop member 90 can include a prop body 91 and flanges 92. The flanges 92 can also be described as tracks on opposing sides of the prop body 91. The prop body 91 can be received into a receiving slot 97. The receiving slot 97 can be provided on or in the bottom face 30 of the base assembly 20.

As shown in FIG. 13, opposing side grooves 98 can run along opposing sides of the receiving slot 97. The opposing side grooves 98 can engage with the side flanges 92 of the sliding prop member 90. Such arrangement can enhance a smooth sliding interaction, enhance stability of the sliding prop member 90, and enhance frictional interaction between the sliding prop member 90 and the base body portion 21. Accordingly, a user can manipulate the sliding prop member 90 to a desired position, with the sliding prop member 90 frictionally held at the desired position.

As described above, FIG. 5 shows a pair of pins 96 in the base body portion 21 of the base assembly 20. Such pins 96 can engage with pin slots 93 in the sliding prop member 90. Such pin slots 93 are shown in FIG. 17, for example. Accordingly, the pins 96 in the pin slots 93 can constrain or limit sliding movement of the sliding prop member 90.

FIG. 14 also shows metal disk 37. The metal disk 37 can be circular or round. The metal disk 37 can be molded into or integrated into the bottom face 30 of the base assembly 20. The metal disk 37 can provide for attaching the stand to most auto magnet holders for cell phones, for example.

Each of the prop bodies 91 can also include a grip cavity 94. The grip cavity 94 can provide a cavity for gripping the sliding/retractable prop member 90. The grip cavity 94 can be a recessed, shallow recess, or indent into the prop body 91. The grip cavity 94 can be positioned close to or at an end of the prop body 91, as shown in FIG. 14, for example.

As described above, the stand assembly 50 can utilize a plurality of ball plungers or protuberances 85 so as to releasably engage cavities or holes 163. Such ball plungers can be short nose spring plungers or other type ball plungers. In such mechanism, a ball can be retained in the mechanism such that the ball is spring-loaded to protrude out from a surface of the stand assembly 50. However, upon pressure being exerted on the ball plunger, the ball plunger can be depressed into the raised Center platform or center boss. Such depression of the balls of the ball plunger allow the engagement assembly 100, with cavities 163, to rotate. Once the balls of the ball plunger 85 or aligned with another cavity 163, the balls of the ball plunger 85 will again click into place (in the respective cavity) so as to click the engagement assembly 100 into the desired position.

The arrangement of the ball plungers 85 engaging with the cavities 163 can, in this illustrative example, provide for locating and holding 8 different circular positions when connected to the 360° rotating platform, i.e. when connected to the engagement assembly 100 that can rotate as desired.

Each of the pins 96, 147 can be positioned in a suitable aperture in the structure in which the pin is secured. The pin can be in the form of a spring pin, which can also be described as a tension pin or role pin. Each pin can include a coiled wall with a slot. Each pin or spring pin can possess, when not under compression, a body diameter that is slightly larger than the whole diameter in which the pin is situated. As a result, when the pin is inserted into the hole, the diameter of the pin is decreased and thus the pin is in a state of compression. Accordingly, compression and/or frictional force can retain the pin in the particular hole. Thus, the pin can be self retaining. Each of the pins can be provided with a chamfer on one or both ends so as to facilitate starting the pin into the particular hole.

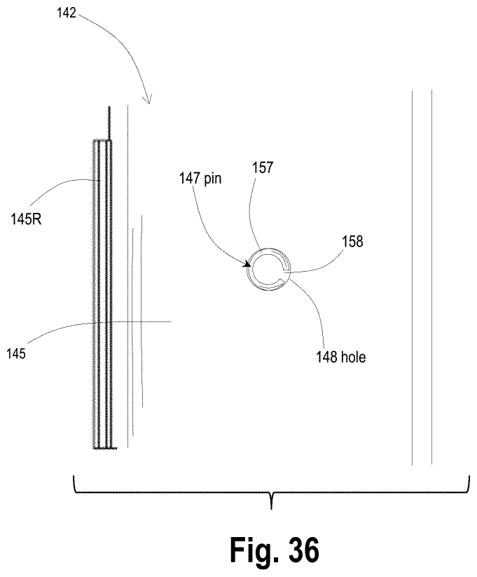

Accordingly, the pin 147 can be positioned in a suitable aperture in structure, such as sliding handle 142, in which the pin 147 is secured. The pin can be in the form of a spring pin. FIG. 36 is a partial view of handle 142 with pin 147. The pin 147 can be inserted into hole 148. The pin 147 can include a coiled wall 157 and a slot 158. The coiled wall 157, as positioned in the hole 148, can be in a state of compression—so that the pin 147 is secured in the hole 148, while extending out of the hole 148 so as to engage with groove or slot 149 of the body portion 101, for example. The pin(s) 96 (to control travel of the prop 90) and other pins as described herein, can be of similar structure.

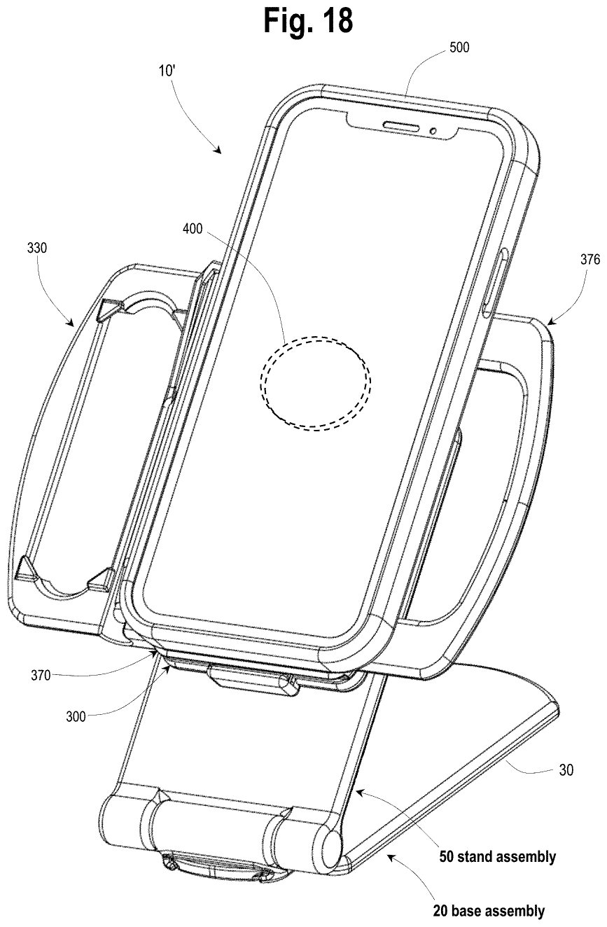

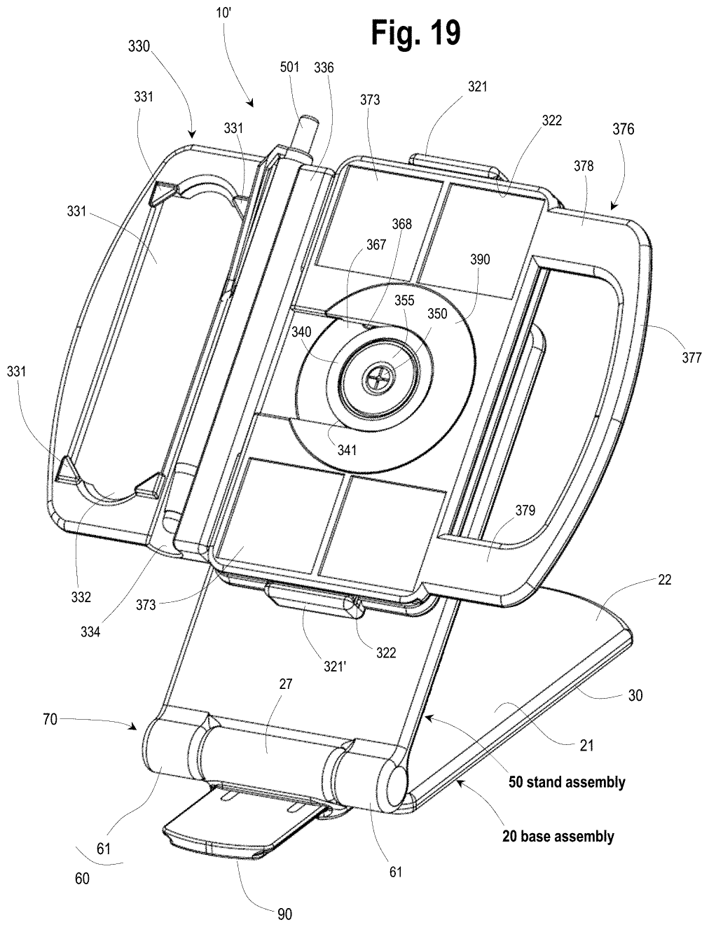

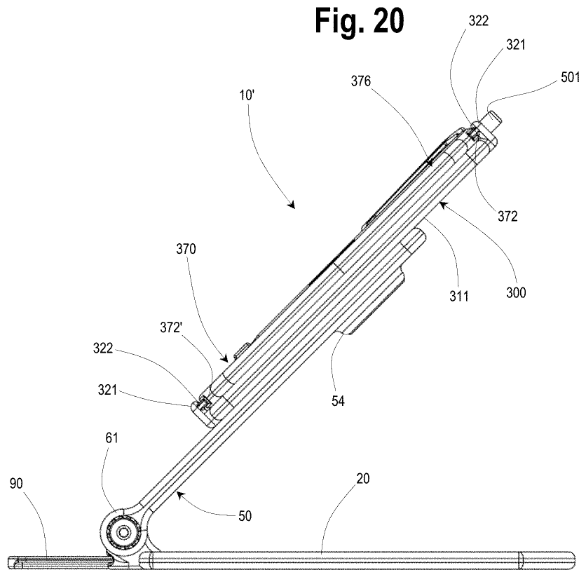

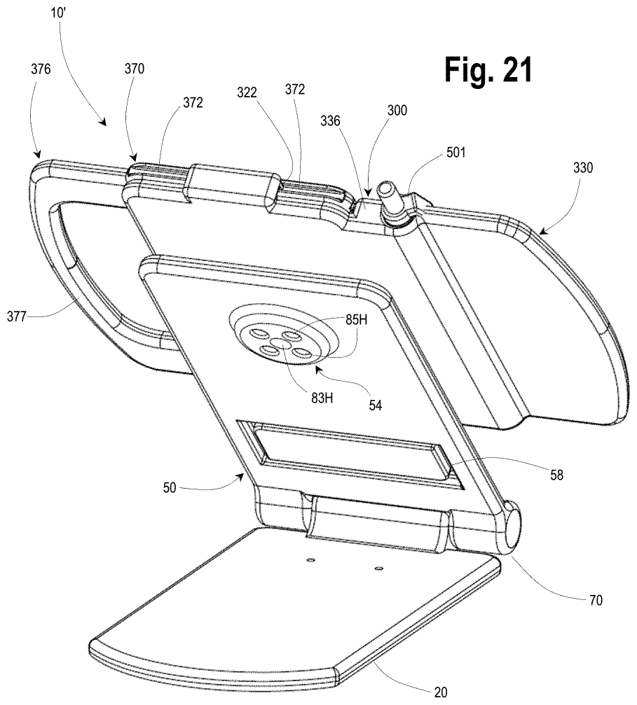

FIG. 18 is a perspective view showing a support device, in accordance with a further embodiment of the disclosure, with user device, in accordance with principles of the disclosed subject matter. FIG. 19 is a perspective view of the support device 10′ of FIG. 18 without user device, in accordance with principles of the disclosed subject matter. Additionally, FIG. 20 is a side view of the support device 10′, in accordance with principles of the disclosed subject matter. Further, FIG. 21 is a back perspective view of the support device 10′, in accordance with principles of the disclosed subject matter.

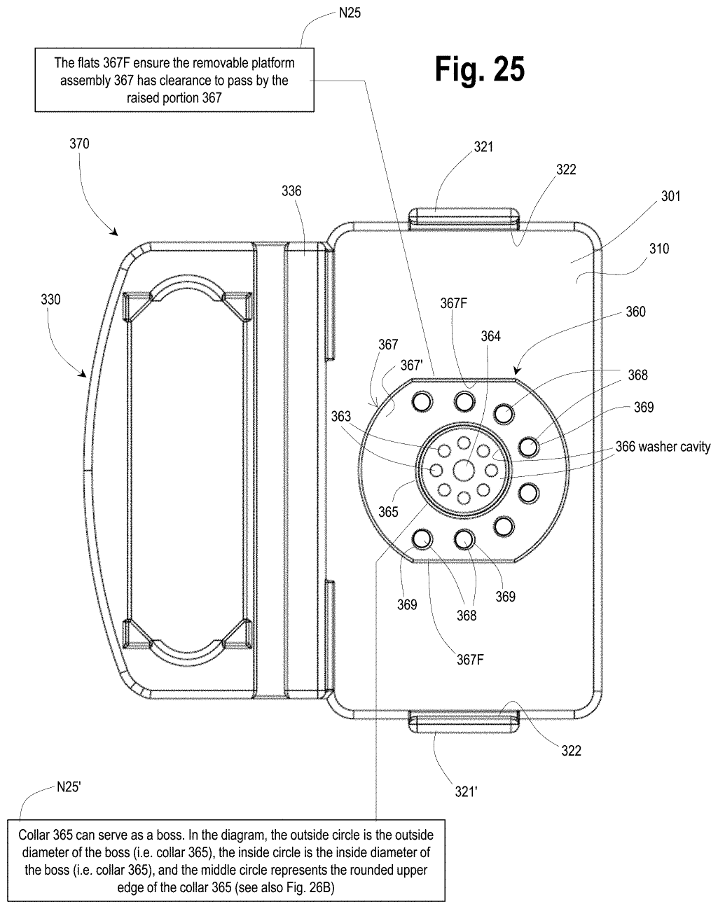

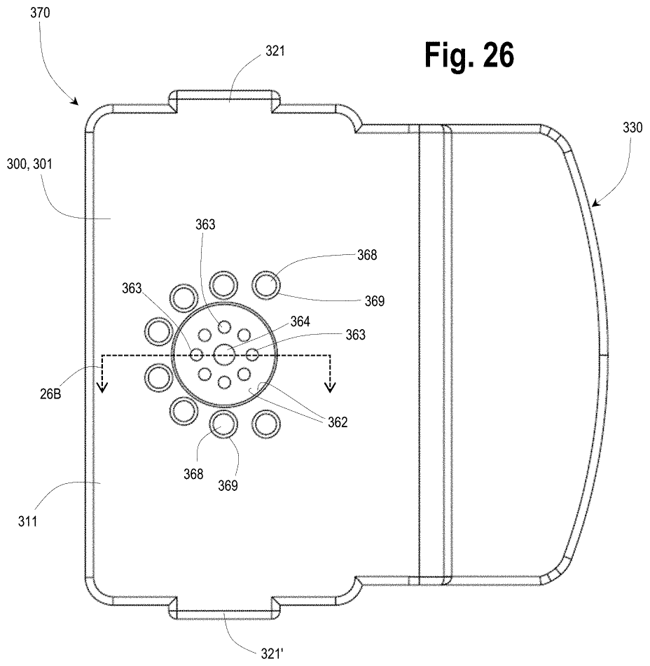

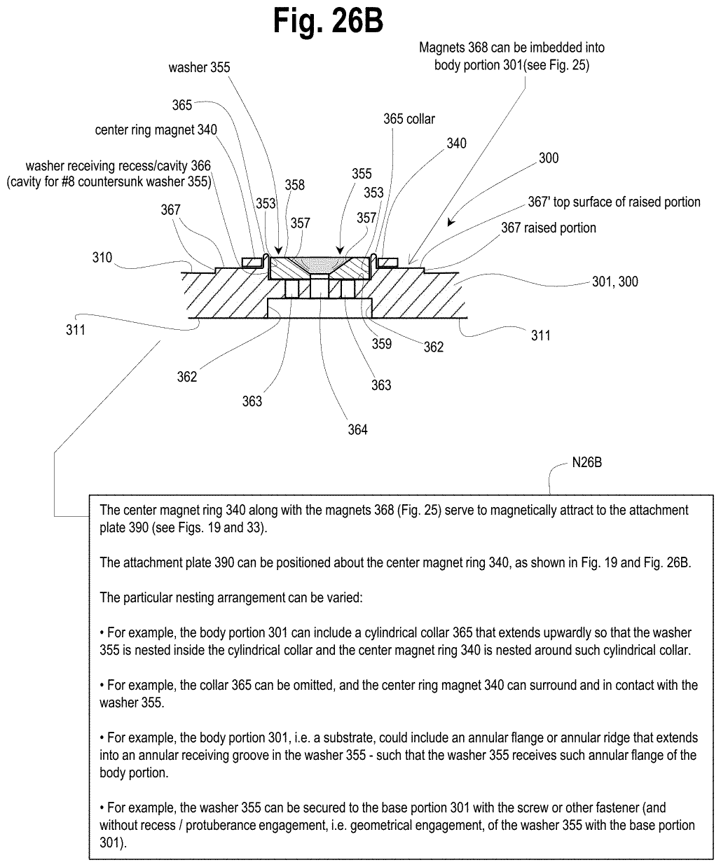

FIG. 25 is a front view of an engagement assembly 300, in accordance with principles of the disclosed subject matter. FIG. 26 is a back view of an engagement assembly 300, in accordance with principles of the disclosed subject matter. FIG. 26B is a cross-section diagram along line 26B of FIG. 26, showing further details of the body portion 301 of the engagement assembly 300, in accordance with principles of the disclosed subject matter.

As shown in FIG. 19 and FIGS. 25-26, for example, the support device 10 includes an engagement assembly 300. The engagement assembly 300 can be rotatably attached and disposed upon the stand assembly 50, as described below. The engagement assembly 300 can include a body portion or base portion 301. The body portion 301 can include a front face 310 and a back face or rear face 311.

As shown in FIG. 19 and FIG. 20, for example, the engagement assembly 300 can slidably receive a platform assembly 370. The platform assembly 300 can be described as a removable platform 300. A cell phone or other user device can be removably attached to the platform assembly 370. For example, the user device / cell phone can be attached to a magnet 400 (FIG. 18 shown in phantom) via adhesive, so that such unit (cell phone plus magnet) is attracted and attached to the magnets of the support device 10 and the platform assembly 370. For example, the user devise can be attached to the platform assembly 370 via adhesive, such as double sided tape.

The engagement assembly 300 can include an upper receiving shoulder 321 and a lower receiving shoulder 321′. The receiving shoulder or upper receiving shoulder 321 can include a guide flange 322. The receiving shoulder or lower receiving shoulder 321′ can include a guide flange 322′. The guide flange 322 can extend into or be inserted into a guide slot 372 of the platform assembly 370. The guide flange 322′ can extend into or be inserted into a guide slot 372′ of the platform assembly 370. The engagement of the guide flanges 322, 322′ with the guide slots 372, 372′, respectively, can provide for the platform assembly 370 to be slidably and removably supported on the base portion 301. The guide slot 372 can be on or integrated into an upper edge 371 of the platform assembly 370. The guide slot 372′ can be on or integrated into a lower edge 371′ of the platform assembly 370. It should be appreciated that alternatively, the receiving shoulders 321, 321′ could be provided with slots that receive flanges of the platform assembly 370. In other words, it should be appreciated that the “tongue and groove” arrangement could be reversed between the base portion 301 and the platform assembly 370.

As shown in FIG. 19 and FIG. 25, for example, the engagement assembly 300 can include an extension assembly 330. The extension assembly 330 can extend off to one side of the body portion or base portion 301.

The extension assembly 330 can include a note cavity 331. The extension assembly 330 can also include pad retaining flanges or retaining flanges 335. The retaining flanges 335 can also be described as corner ledges 335. The corner ledges 335 can be provided to support and secure a notepad that is positioned on or in the note cavity 331. The note pad (not shown) can also be provided with an adhesive backing that adhesively secures to the note cavity 331. The extension assembly 330 can also include access grooves 332. The access grooves 332 can be provided at the top and at the bottom of the note cavity 331. The access grooves 332 can be provided to assist in removing a notepad from the note cavity 331 and to assist in positioning a notepad in the note cavity 331. In particular, the access grooves 332 can be helpful in positioning or “tucking” the corners of a notepad behind the corner ledgers 335.

The extension assembly 330 can also include a receiving cavity 334. The receiving cavity 334 can be provided to retain a pen, pencil, stylus, or other writing device 501. The receiving cavity 334 can include or be in the form of a clip that engages with a pen or stylus, for example.

The extension assembly 330 can also include a stop wall 336. The stop wall 336 can be positioned alongside the receiving cavity 334. The stop wall 336 can serve to support, at least in part, the writing device 501. The stop wall 336 can extend outwardly from and provide a divider between the extension assembly 330 and the base portion 301. Also, stop wall 336 can provide a stop, so as to stop lateral sliding movement of the platform assembly 370.

As described above, the engagement assembly 300 can be rotatably secured upon the stand assembly 50.

The stand assembly 50 can be similar in structure to the stand assembly 50 of the support device 10, as described above. In particular, the first rotation assembly or rotation assembly 80, of the stand assembly 50, can be similar in structure to that described above with reference to the embodiment of the support device 10. The engagement assembly 300 can include a rotation assembly or second rotation assembly 360. The engagement assembly 300 with second rotation assembly 360 can rotatably be positioned on and secured to the first rotation assembly 80.

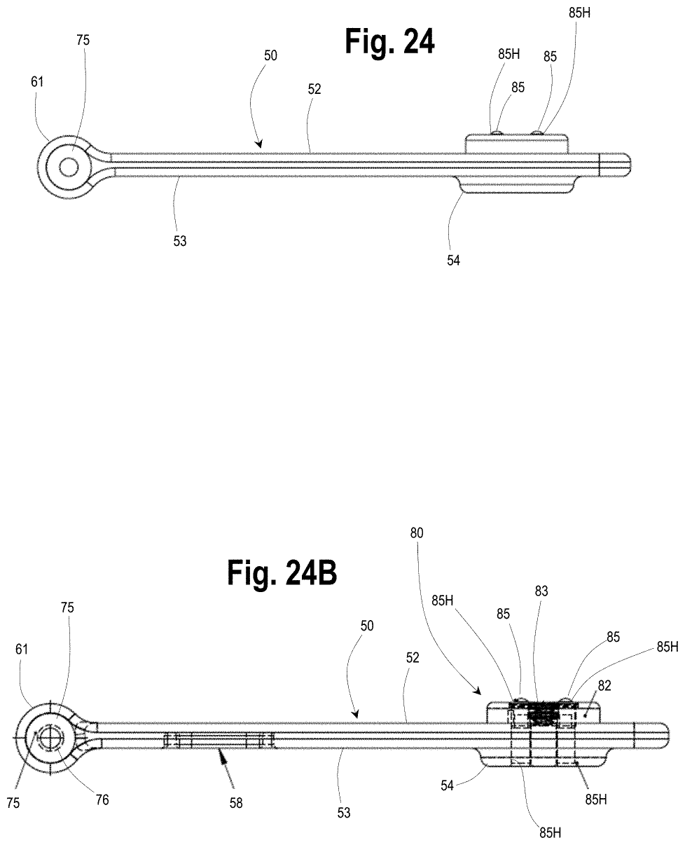

The second rotation assembly 360, as shown in FIG. 26 and FIG. 26B, can include a mating attachment recess 362. The mating attachment recess 362 can rotatably engage with and accept the raised center platform 82 of the first rotation assembly 80. The second rotation assembly 360 can include cavities or holes 363. The cavities or holes 363 can receive the ball plungers or protuberances 85, of the first rotation assembly 80. As otherwise described herein, such arrangement allows a user to “click” the engagement assembly 300 at different rotation positions on the stand assembly 50. As a result of the ball plunger, or protuberance, being removably into a receiving hole 363, the engagement assembly 300 can be set at a desired rotation position, by a user. However, if sufficient force is applied by the user, the ball plungers 85 can be “popped out” of a receiving cavity 363—so as to allow rotation of the engagement assembly 300 to a desired position. Accordingly, rotation of a user device or cell phone is provided for by such arrangement. The depth of the mating attachment recess 362 can be constructed so as to match or correspond with the height that the raised center platform 82 is raised (see FIG. 24, for example). In general, the geometry of the mating attachment recess 362 can be constructed so as to mate or correspond with the raised center platform 82.

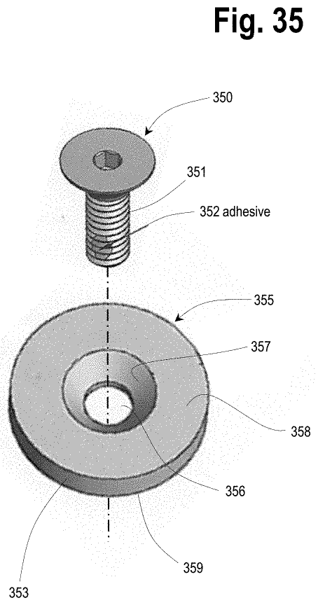

FIG. 35 is a perspective view of a washer 355 and screw 350 arrangement that is a component of the support device 10′, in accordance with principles of the disclosed subject matter. The washer 355 can be a chamfered or countersunk washer. The washer 355 can be a finishing washer. The washer 355 can be received into a washer receiving recess 366 of the base portion 301. The washer receiving recess 366 can also be described as a washer cavity 366. The washer receiving recess 366 is shown in FIG. 25 and FIG. 26B, for example. The screw 350 can pass through the washer 355 and through an attachment hole 364. The screw 350 can be rotatably disposed in the attachment hole 364. The screw 350 can be threaded into an insert 83 with attachment hole 84, which is threaded to receive the screw 350. The screw can include adhesive 352 to lock into place in insert 83 and avoid loosening.

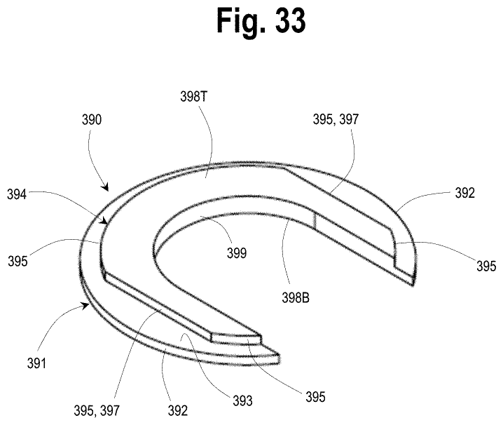

As shown in FIG. 25 and FIG. 26B, and described at N25′ in FIG. 25 and at N26B in FIG. 26B, the body portion 301 (of the engagement assembly 300) can include a collar or annular collar 365. The collar 365 can be in the form of a ring or short cylinder 365 that extends up from the raised portion 367, i.e. extends up from a top surface 367′ (at an inner periphery of the top surface 367′). Further details of the collar 365 and engagement assembly 300, and different embodiments, are described at N26B of FIG. 26B. A center magnet ring 340 along with the magnets 368 (FIG. 25) can collectively serve to magnetically attract the attachment plate 390 (see FIGS. 19 and 33). The center magnet ring 340 can be in the form of a washer that is magnetized.

As shown in FIG. 26B and FIG. 19, the attachment plate 390 can be positioned about the center magnet ring 340.

The particular nesting arrangement can be varied. For example, a recess in a first part that accepts a second part (that extends into such recess) could be flipped so that the second part is provided with a recess that accepts the first part into such recess.

For example, as shown in FIG. 26B, the body portion 301 can include the cylindrical collar 365 that extends upwardly so that the washer 355 is nested inside the cylindrical collar and the center magnet ring 340 is nested around such cylindrical collar.

For example, the collar 365 can be omitted, and the center ring magnet 340 can be surrounding and in contact with the washer 355.

For example, the body portion 301, i.e. a substrate, could include an annular inner flange or annular ridge that extends into an annular receiving groove in the washer 355—such that the washer 355 receives such annular flange of the body portion.

An upper surface of the body portion 367 could be flat and the position of the washer 355 maintained solely by the screw or bolt 350.

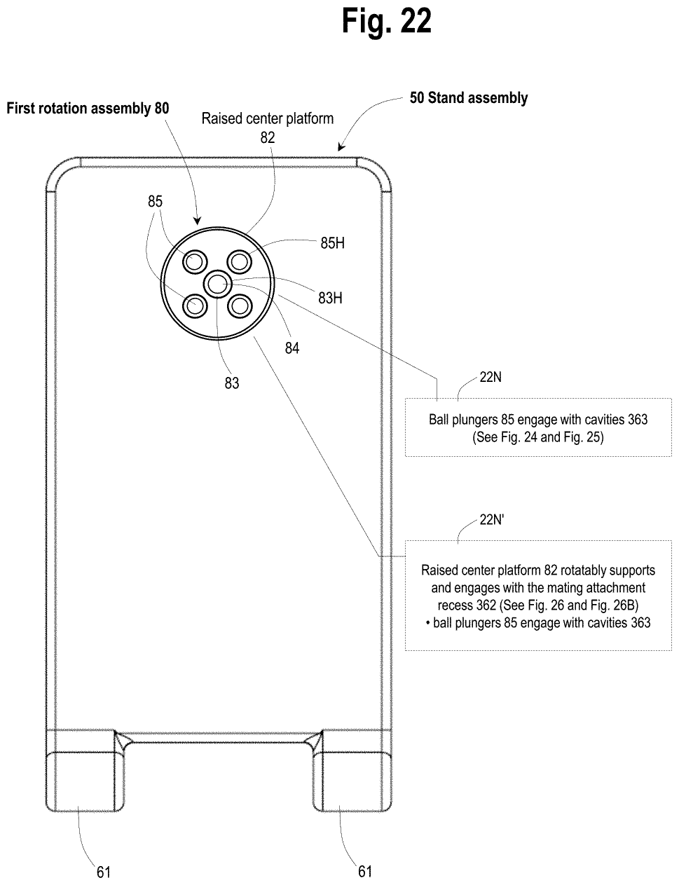

As reflected in FIG. 22 at 22N′, the raised center platform 82 (of stand assembly 50) can rotatably support and engage with the mating attachment recess 362, with the ball plungers 85 selectively engaging with the cavities or holes 363, as reflected in FIG. 22 at 22N. The screw 350 can include threads 351. The threads 351 can be provided with adhesive, for example, so as to retain the screw 350 secured in threaded hole 84 of the stand assembly 50) and rotatably passing through the attachment hole 364. The washer 355 can include hole 356 with a chamfer 357 so as to nest with the screw 350. The washer 355 can include a lower surface 359 that seats into the washer receiving recess 366. The washer 355 can include an upper surface 358 and an outer peripheral surface 353 or outer surface 353. The ball plungers 85 can be short nosed spring plungers, for example, or other type of ball plunger can be used as desired.

As shown in FIG. 19, a center ring magnet 340 can be positioned about the washer 355 and/or about the collar 365. The center ring magnet 340 or ring magnet 340 can be secured onto the body portion 301 by magnetic attraction to the washer 355, to the magnets 368, and other components of the engagement assembly 300. The ring magnet 340 can include in outer surface 341. The outer surface 341 can engage with and support the attachment plate 390, as shown in FIG. 33.

As shown in FIG. 25 and FIG. 26B, for example, the front face 310 of the base portion 301 can include a magnet receiving raised area or plateau 367 with top surface 367′. The magnet receiving raised area 367 can be a raised portion or area on the front face 310. The magnet receiving raised area 367 can extend about or around the washer cavity 366 and collar 365. The magnet receiving raised area 367 can be an area, having a top surface 367′, in which a plurality of holes 369 are disposed. The holes 369 can be for a respective magnet 368. The magnets 368, in the holes 369, can provide an attachment element to provide magnetic and removable securement to the attachment plate 390, such as is shown in FIG. 19. The various holes 369 can collectively form a “moon shape” as shown in FIG. 25. Such positioning of the holes 369, with magnets 368 contained therein, can provide an aesthetically pleasing arrangement as shown in FIG. 25 and effectively provide magnetic and removable attachment to the attachment plate 390.

The raised area 367 can including a flattened sides 367F, as shown in FIG. 25. In accordance with at least one embodiment of the disclosed subject matter, the flats 367F ensure the removable platform assembly 367 has clearance to pass by the raised portion 367, as noted at N25 of FIG. 25. That is, the flats 367F ensure the removable platform assembly 367 has clearance to pass by the raised portion 367 as the platform assembly 367 is slid on and off of the base portion 301. In some embodiments, the raised area 367 might not be raised, but rather flush or flat with the surrounding area of the base portion 301.

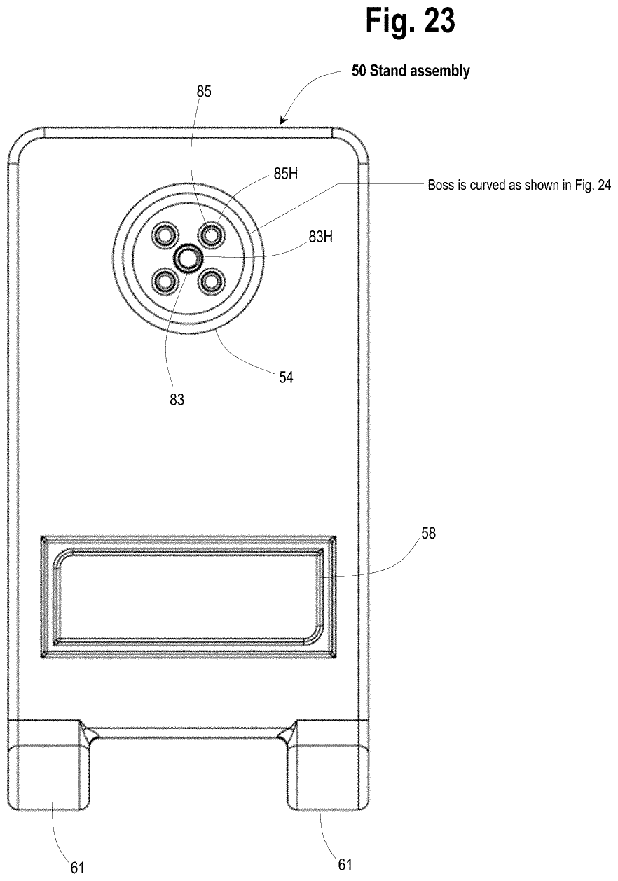

FIG. 22 is a front view of a stand assembly 50, in accordance with principles of the disclosed subject matter. FIG. 23 is a back view of the stand assembly 50, in accordance with principles of the disclosed subject matter. FIG. 24 is a side view of the stand assembly 50 of the support device 10′ in a closed position, in accordance with principles of the disclosed subject matter. FIG. 24B is a further side view of the stand assembly 50 of the support device 10′ in a closed position, showing further details in phantom, in accordance with principles of the disclosed subject matter. The stand assembly 50, of the stand assembly 10′, can be of similar or same structure to that described above with reference to the embodiment of the support device 10. Accordingly, as shown in FIG. 21, the platform stopping boss 54 can include a hole 83H for accepting insert 83 (with threaded hole 84) and holes 85H for accepting ball plungers 85, as also shown in FIG. 24 and FIG. 24B. Accordingly, the stand assembly 50, in at least some embodiments, can engage either the engagement assembly 100 (FIG. 2) or the engagement assembly 300 (FIG. 19). The insert 83 can be a 8-32×¾ T Nut-Brad hole Threaded Insert, for example. However, another type of threaded insert can be used as desired.

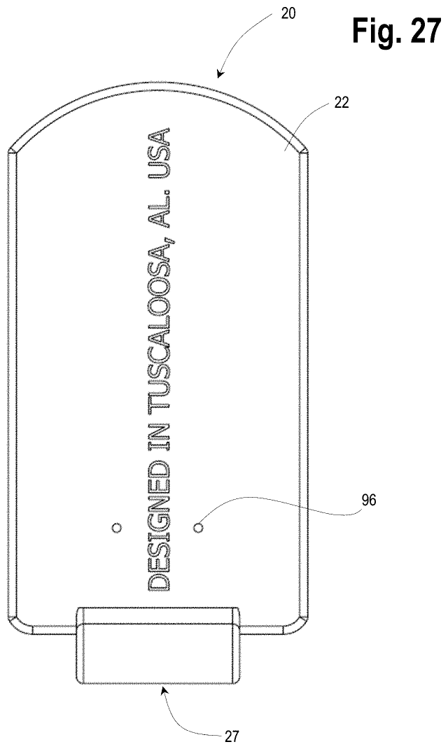

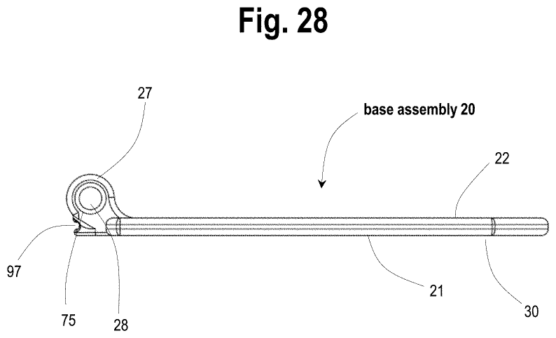

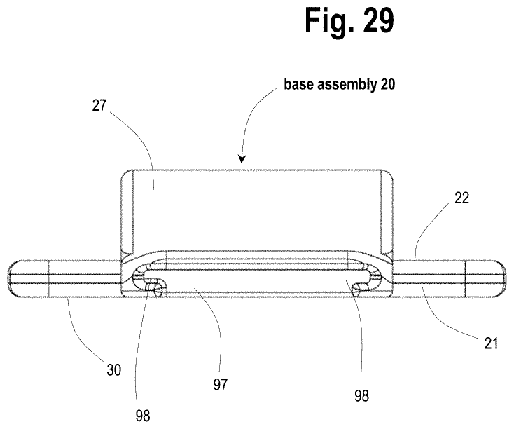

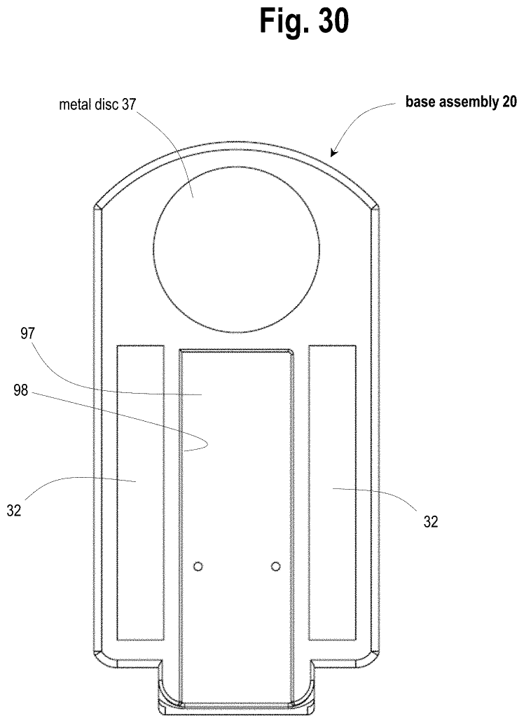

FIG. 27 is a top view of the base assembly 20, in accordance with principles of the disclosed subject matter. FIG. 28 is a side view of the base assembly 20 in accordance with principles of the disclosed subject matter. FIG. 29 is an end view of the base assembly 20, in accordance with principles of the disclosed subject matter. FIG. 30 is a bottom view of the base assembly 20, in accordance with principles of the disclosed subject matter. The base assembly 20, of the support device 10′, can be of similar or same structure to that utilized in the support device 10, as described above.

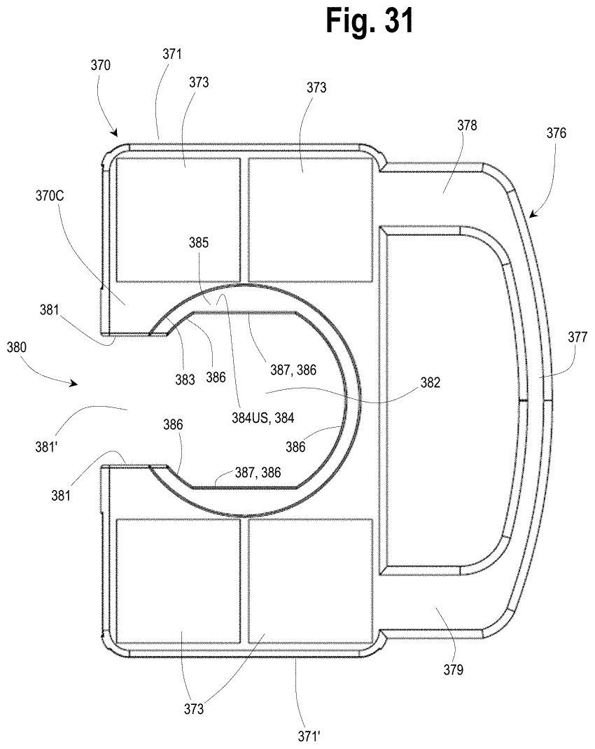

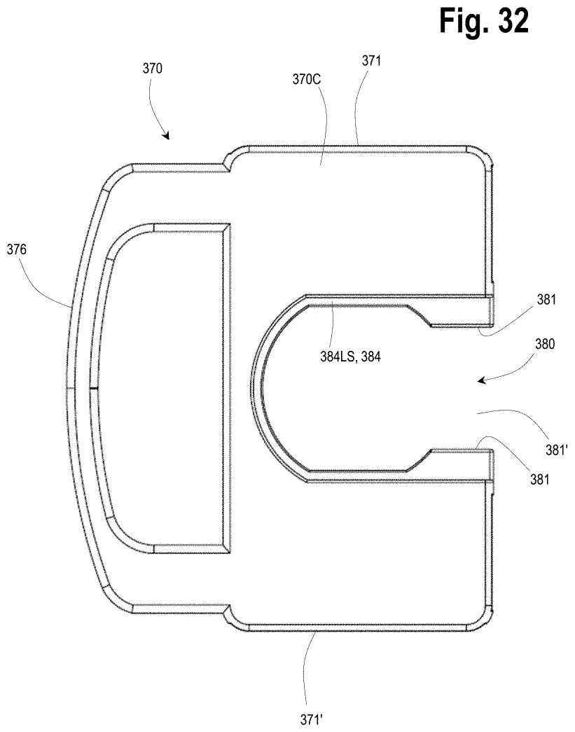

FIG. 31 is a front view of a platform assembly 370 that is a part of the engagement assembly 300, in accordance with principles of the disclosed subject matter. FIG. 32 is a back view of a platform assembly 370 of FIG. 31, in accordance with principles of the disclosed subject matter. FIG. 33 is a diagram showing the attachment plate 390, in accordance with principles of the disclosed subject matter.

As described above, the platform assembly or removable platform 370 can include guide slots 372, 372′ so as to removably attach the platform assembly 370 onto the base portion 301. The platform assembly 370 can include a handle 376. The handle 376 can allow a user to easily manipulated the platform assembly 370. The handle 376 can include a grip portion 377. The handle 376 can also include a top attachment prong 378 and a bottom attachment prong 379. The attachment prongs 378, 379 can attach the grip portion 377 onto a core portion 370C of the platform assembly 370. The core portion 370C can include a plurality of note pad cavities 373. The note pad cavities 373 can respectively provide an attachment area so as to support a suitably sized notepad. A notepad can be provided with an adhesive backing so as to adhesively attached to a respective note pad cavity 373.

The platform assembly 370 can include an engagement slot 380. The engagement slot 380 can be described as a boss engagement slot 380 or a receiving engagement slot 380. The engagement slot 380 engages with and receives the center ring magnet 340 of the engagement assembly 300.

The engagement slot 380 includes a slot opening surface 381. The slot opening surface 381 defines a slot opening 381′. The engagement slot 380 includes a slot expanded inner portion 382, as shown in FIG. 31, for example. The slot expanded inner portion 382, of the engagement slot 380, includes an outer engagement surface 383. The outer engagement surface 383 can be circular in shape.

The engagement slot 380 can also include an engagement flange 384. The engagement flange 384 can wrap around or extend around a portion of the engagement slot 380, as shown in FIG. 31. The engagement flange 384 can be in the form of a web or thinned segment of material that is recessed into the opposing front and back surfaces of the platform assembly 370. In particular, the engagement flange 384 can form or define a plate cavity 385. The plate cavity 385 can be formed by the engagement flange 384 and can receive the attachment plate 390. More specifically, the plate cavity 385 can receive a base portion 391 of the attachment plate 390. The engagement flange 384 can include an inner engagement surface 386. The inner engagement surface 386 can include a locking flat 387. The locking flat 387 can engage with the attachment plate 390 so as to prevent rotation between the platform assembly 370 and the attachment plate 390.

To explain further, the attachment plate 390 can be a metal and magnetic plate. The attachment plate or plate 390 can include the base portion 391 as shown in FIG. 30. The base portion can include an outer engagement surface 392. The outer engagement surface 392 can be circular in shape and can engage with the outer engagement surface 383, of the engagement slot 380. The base portion 391 can include a top face or shelf 393 of the base portion 391. The face or shelf 393 can be seated onto the engagement flange 384.

The attachment plate 390 can also include a raised portion 394. The raised portion 394 can fit into and be engaged with the inner engagement surface 386 and the locking flat 387. The raised portion 394 can provide a second level to the attachment plate. The raised portion 394 can include an outer engagement surface 395. The outer engagement surface 395 can include a locking flat 397, which engages with the locking flat 387. Accordingly, rotation between the platform assembly 370 and the attachment plate 390 can be prevented by the locking flats 387, 397. The attachment plate 390 can be seated onto the platform assembly 370 by the base portion 391 positioned onto the engagement flange 384, i.e. and specifically onto an upper surface 384US of the engagement flange 384. The engagement flange 384 can include an opposing or lower surface 384LS.

As shown in FIG. 30, the plate 390 can include a top face 398T and a lower or bottom face 398B. The plate 390 can also include an inside engagement face 399 or engagement surface 399. The engagement surface 399 can engage with and be positioned about the center ring magnet 340. Accordingly, the attachment plate 390 and platform assembly 370 can be attached onto the body portion 301.

A user device, such as a cell phone 500, can be attached to the platform assembly 370. The cell phone 500 can be adhesively attached to the platform assembly 370. The cell phone 500 can be attached to a magnet. For example, the cell phone can be adhesively attached to the magnet. The cell phone with magnet, as a unit, can be attached onto the platform assembly 370, as such platform 370 is shown in FIG. 19.

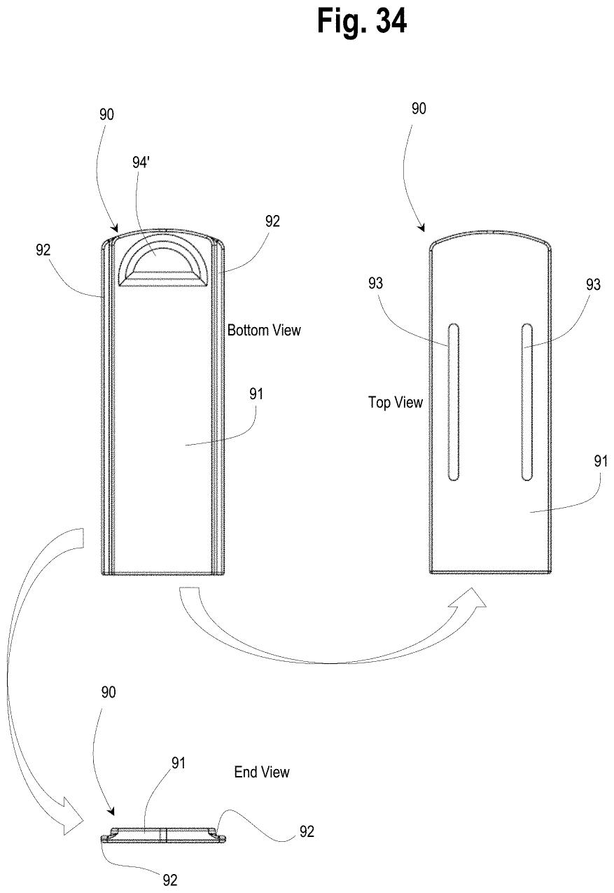

FIG. 34 are multiple views of a sliding prop member 90, in accordance with principles of the disclosed subject matter. The sliding prop member 90 can be of similar structure as the sliding prop member 90 shown in FIG. 17. However, in a variation of such structure, the sliding prop member or prop member 90 can include a different grip cavity 94′. The grip cavity 94′ can be half circle shaped, in contrast to the geometry shown in FIG. 17. It is appreciated that other shapes and geometries of the grip cavity 94 can be provided so as to afford an aesthetically pleasing experience and to effectively engage with a user's finger to allow manipulation of the prop member 90. For example, the prop member 90 can afford stability to the support device 10 or the support device 10′.

The support device 10, 10′ of the disclosure provides various advantages and benefits. As shown in FIG. 1 and in FIG. 18, a user device, such as a cell phone, can be attached onto the support device 10, 10′. For example, the cell phone can be attached onto the support device using double-sided tape. For example, the engagement assembly 100 or the engagement assembly 300 can be rotated from the base assembly 20 such that the engagement assembly 100, 300 can be laid flat on a table or other supporting surface. The double-sided tape or other double-sided adhesive substrate can then be positioned upon the engagement assembly 100, 300. For example, the double-sided adhesive substrate (one or more pieces) can be applied to the platform assembly 370. The user device, such as a cell phone, can then be “pressed onto” the double-sided adhesive substrate. Accordingly, the user device can be attached onto the platform assembly 370 or onto the engagement assembly 100, for example. Thus, with the “platform” placed on a table or other supporting surface, the phone can be easily and effectively attached to the platform using the sticky tape or other double-sided adhesive tape. The user device can be pushed onto the platform using a suitable amount of pressure so as to attain the desired level of attachment. The bottom of the phone or other user device can be lined up with the bottom of the platform, such as the platform assembly 370.

Also, a magnet can be adhesively attached to the user device—in the magnet in turn attached to the engagement assembly 100 or the engagement assembly 300.

With the embodiment of the support device 10′, the platform assembly 370 can be removed from the base portion 301 so as to adhesively attach the cell phone to the platform assembly 370. With the embodiment of the support device 10, the engagement assembly 100 can be removed from the stand assembly 50, for example.

With further reference to FIG. 18 and FIG. 19, for example, once the phone is attached to the platform assembly 370, the platform assembly 370 can be slid into the base portion 301. The arrangement provides a helpful arrangement of features that affords various benefits. The arrangement of the disclosure is easily manipulated so as to provide helpful features.

With the support device 10 or the support device 10′, the arrangement can act a bit like an old-fashioned telephone cradle, allowing one to use the built-in handle to take the user's phone on and off the stand or stand assembly 50 as desired. Once the user has completed his or her call, the user can put her phone back on the stand assembly 50.

The engagement assembly 100 and the engagement assembly 300 both allow rotation of a user device on the stand assembly 50. The sliding handle 142 or the handle 376 of the embodiments can allow easy manipulation of a user's phone including holding the user's phone and rotating the user's phone on the stand assembly 50, i.e. when the user's phone is supported on the stand assembly 50. For example, the arrangement of the handle of the respective embodiments can enable one to spin the phone from horizontal to vertical positions while also providing a 90° up and down stand, stopping at any angle for viewing, hands-free.

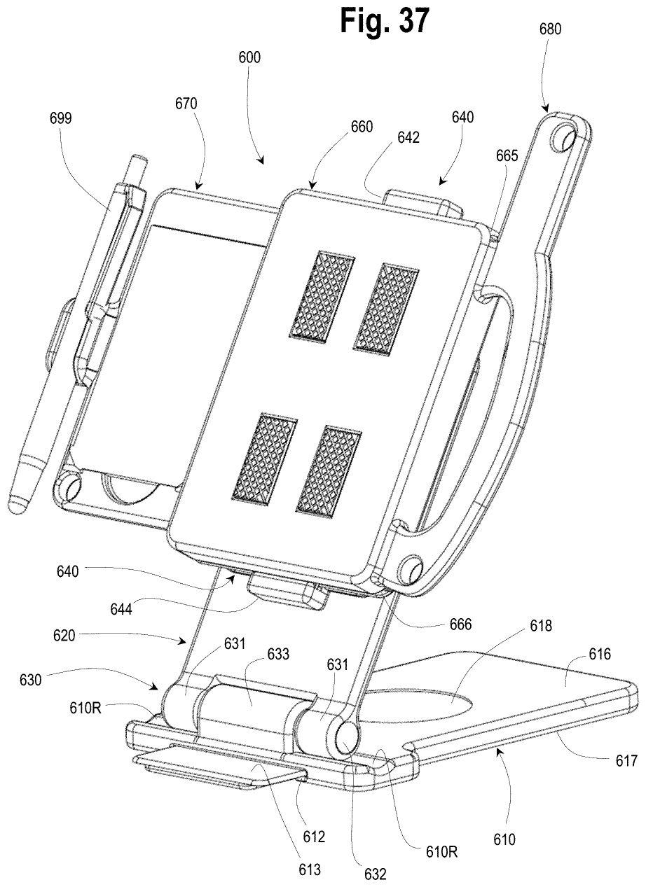

FIG. 37 is a perspective view showing a support device 600, in accordance with a further embodiment of the disclosure, in accordance with principles of the disclosed subject matter. The support device 600 can include a base assembly 610, a stand assembly 620, and an engagement assembly 640. The support device 600 can also include a removable platform assembly 660. The removable platform assembly 660 can be removably mounted onto the engagement assembly 640. The support device 600 can also include a slide desk or desk 670. The slide desk 670 can be slidably supported by the removable platform assembly. The slide desk 670 can be positioned in an extended position as shown in FIG. 37. The slide desk 670 can then be pushed into or slid into the removable platform assembly 660 such that the slide desk 670 is in a retracted or stowed position. Further details of the manner in which the slide desk 670 is slidably disposed relative to the removable platform assembly 660 are described below.

The base assembly 610 can support the support device 600 on a supporting surface or a supporting structure. The base assembly 610 can include a top surface 616 and a bottom surface 617. The base assembly can include a groove or relief 610R that provides clearance for rotation of the hinge barrels 61.

The base assembly 610 can include an attachment element 618. The attachment element 618 can be positioned in a recess as shown in FIG. 37. The attachment element 618 can be integrally formed with the base assembly 610. The attachment element can be a magnet. The attachment element can be a plate or block of metal that can be attracted to a magnet on a supporting surface. The bottom surface 617 of the base assembly 610 can be provided with hook and loop fasteners (Velcro), adhesive tape or other adhesive material, one or more suction cups, and other attachment mechanisms. The base assembly 610 can be provided with any attachment mechanism or other feature as described in other embodiments in this disclosure.

A sliding prop member 613 can be slidably disposed in a prop recess 612. The sliding prop member 613 can be slid from a stowed position to an extended position. In the extended position, the sliding prop member 613 can extend out from the base assembly 610, so as to support the base assembly 610. The sliding prop member 613 can have flanges or ridges on opposing sides so as to engage with structure of the prop recess 612. The sliding prop member 613, the prop recess 612, and related structure can be of similar construct to, and include features of, the sliding prop member 90, the receiving slot 97, and related structure shown in FIGS. 19, 20, 29, 30, and 34, for example. Any feature described herein in the context of one embodiment can be used in other embodiments as desired.

As shown in FIG. 37, the support device 600 can include a hinge assembly 630. The hinge assembly 630 can provide rotatable connection between the stand assembly 620 and the base assembly 610. That is, the hinge assembly 630 can serve to rotatably support the stand assembly 620 upon the base assembly 610.

The hinge assembly 630 can include opposing hinge barrels 631 that are connected to or integrally formed with the stand assembly 620. The hinge assembly 630 can also include a center hinge barrel 633. The center hinge barrel 633 can be rotatably supported between the opposing hinge barrels 631 using a hinge pin assembly 632. The hinge pin assembly 632 can be tightened or loosened so as to provide a desired degree of friction between the center hinge barrel 633 and the hinge barrels 631. The hinge assembly 630 can be of similar construct to, and include features of, the hinge assembly 70 shown in FIGS. 19-25.

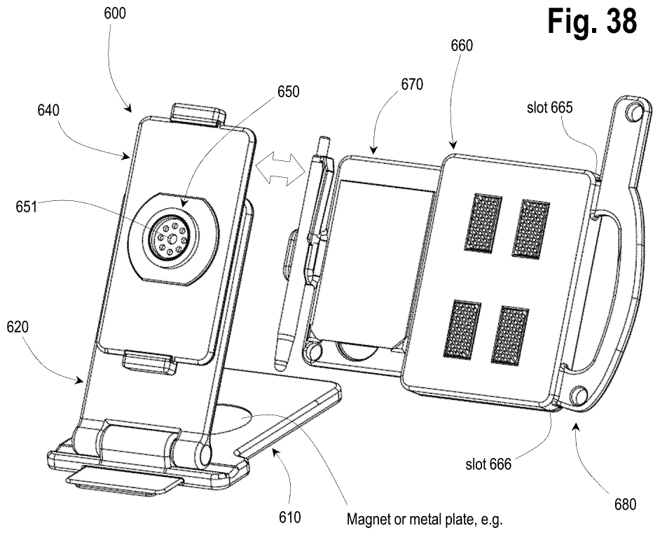

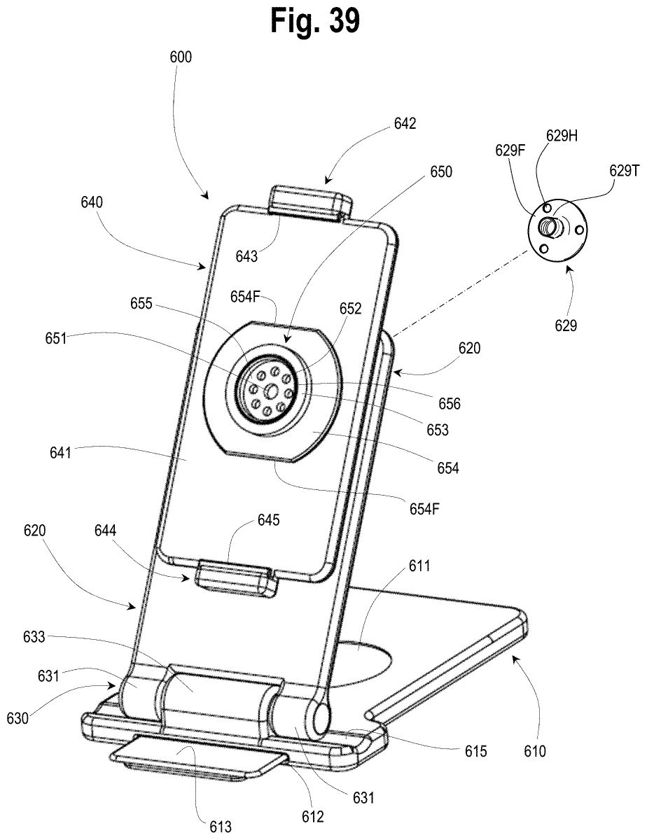

As described above, the support device 600 can include an engagement assembly 640. FIG. 39 is a top perspective view of a support device 600 with the removable platform assembly 600 and a slide desk 670 removed or omitted. Relatedly, FIG. 38 is a top perspective view of a support device 600 showing a sliding relationship between the engagement assembly 640 and the removable platform 660.

With reference to FIG. 39, the engagement assembly 640 can be rotatably mounted on the stand assembly 620. The engagement assembly 640 can include a body or body portion 641. The engagement assembly 640 can include a second rotation assembly 650. The second rotation assembly 650 can rotatably engage with a first rotation assembly (not shown in FIG. 39) of the stand assembly 620.

As shown in FIG. 21, the stand assembly 50 rotatably supports an engagement assembly 300. That is, in similar manner, the engagement assembly 640 can be rotatably supported on the stand assembly 620. Similar to structure shown in FIG. 24, the stand assembly 620 can include a raised platform or raised center platform 82. The raised platform 82 can be provided with a plurality of spring loaded ball plungers or ball plungers 85. The ball plungers 85 can selectively engage with the ball plunger recesses 652.

Instead of the ball plungers, knobs or protuberances can extend from the stand assembly 620 so as to selectively engage with ball plunger recesses 652. The back of the engagement assembly 640 can include a recess so as to receive and mate with such a raised center platform 82 (with ball plungers) of the stand assembly 620.

As shown in FIG. 39, the second rotation assembly 650 can include a center portion or recessed portion 655. The recessed portion 655 can be a circular area in which the ball plunger recesses 652 are positioned. Each of the ball plunger recesses can be through holes. That is, each of the ball plunger recesses 652 can be through holes such that ball plungers (extending out from the stand assembly 620) can pass into the ball plunger recesses 652. As a result, as otherwise described herein, the ball plunger recesses 652 can be selectively engageable with ball plungers 85 and can serve to hold the engagement assembly 640 in a desired rotational position. For example, the engagement assembly 640 can be rotated from portrait to landscape viewing of a supported smart phone. The recessed portion 655 can also include centering aperture or attachment aperture 651. The attachment aperture 651 can extend through the engagement assembly 640.

A suitable fastener can extend through the attachment aperture 651 and pass into a threaded aperture in the stand assembly 620. As a result, the engagement assembly 640 can be secured to the stand assembly 620 in conjunction with being rotatable relative to the stand assembly 620. For example, the stand assembly 620 can include a threaded aperture so as to receive such fastener passing through the attachment aperture 651 of the engagement assembly 640. For example, as described above, the stand assembly 620 can house an insert with a threaded bore, similar to the insert 83 with threaded bore 84 described above and shown in FIGS. 23 and 24B. However, it should be appreciated that any of a wide variety of fasteners and threaded arrangements, such as threaded inserts, can be used so as to attach the engagement assembly 640 onto the stand assembly 620.

FIG. 35 illustrates an arrangement that includes a screw 350 and a washer 355. Such arrangement can be used in the recessed portion 655. That is, the washer 355 can be positioned in the recessed portion 655 and the screw 350 can pass through the washer 355, through the attachment aperture 651, and into a threaded aperture in the stand assembly 620.

For example, instead of the insert 83 (with threaded bore) described above, the stand assembly 620 can be provided with an insert 629, shown in FIG. 39. The insert 629 can be provided with a tube structure 629T that is internally threaded. A flange 629F can extend around the tube structure. Accordingly, the tube structure 629T can extend into an aperture in the stand assembly 620. The insert 629 can threadably accept a fastener (such as fastener or screw 350) that extends in from, and passes through, the attachment aperture 651 (of the engagement assembly 640). The flange 629F can abut up against the back of the stand assembly 620. The insert 629 can include holes 629H in the flange 629F. The holes 629H are provided so that a human user can engage the holes 629H with a suitable tool, so as to prevent rotation of the insert 83. Such can allow tightening or loosening of a screw 350. Relatedly, the back of the stand assembly 620 can also include an aperture that aligns with the aperture or hole 629H. Such arrangement provides for a user to insert a pin or similar tool into the hole 629H so that the insert 83 won't “spin about” as a user is trying to loosen or tighten the screw 350.

With further reference to FIG. 39, the center portion 655 can be surrounded by an inner centering collar 656. As shown in FIG. 39, the center portion or recessed portion 655 can be recessed as compared with the surrounding inner centering collar 656. As described above, a screw 350 and washer 355 (see FIG. 35) can be positioned in the recessed portion 655. Accordingly, the inner centering collar 656 can surround the washer 355. The top of the inner centering collar 656 can be flush with the top of the washer 355.

The screw 350 can pass through the washer 355, through the engagement assembly 640, and extend into insert 629. Rotation between the stand assembly 620 and the engagement assembly 640 can be allowed by not tightening the screw 352 tightly. As described otherwise herein, ball plungers can be used to engage the ball plunger recesses or holes 652, such that the engagement assembly 640 “snaps” from position to position as the user rotates the engagement assembly 640. Any of the attachment structure described herein can be utilized so as to rotatably attach the engagement assembly 640 onto the stand assembly 620.

As shown in FIG. 39, the engagement assembly 640 can also include a centering collar 653. The centering collar 653 can surround the inner centering collar 656. The centering collar 653 can be affixed to the inner centering collar 656 via friction fit, adhesive, or heat bond, for example. The centering collar 653 can be constructed of metal and the inner centering collar 656 can be constructed of plastic. The centering collar 653 can be constructed of metal so as to resist “wear”. That is, the centering collar 653 affords a working contact surface that engages with structure of the removable platform assembly 660. Further details are described below.

The engagement assembly 640 can also include a raised portion 654. The raised portion 654 can be a plateau type structure that surrounds the centering collar 653. The raised portion 654 can include “flats” 654F on the top and bottom of the raised portion 654. The flats 654F can be provided to engage with the removable platform assembly 660.

As shown in FIG. 39, the engagement assembly 640 includes a top receiving shoulder 642 with guide flange 643, as well as bottom receiving shoulder 644 with guide flange 645. The engagement assembly 640 includes the body portion 641 that extends between the top receiving shoulder 642 and the bottom receiving shoulder 644. The receiving shoulders 642, 644 provide slidable engagement to the removable platform assembly 660 as described below.

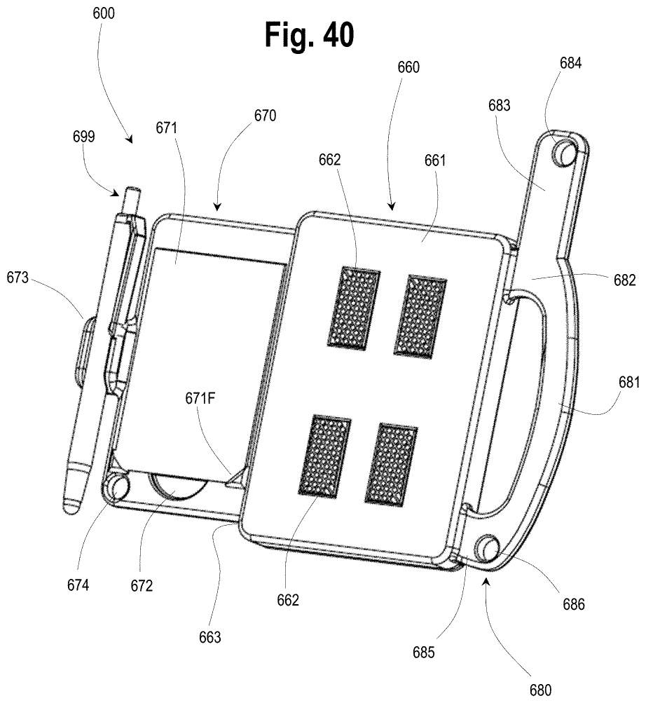

FIG. 40 is a perspective view of removable platform assembly 660, in accordance with principles of the disclosed subject matter. The removable platform assembly 660 can include a platform 661. The platform 661 can include attachment pieces or attachment pads 662. The attachment pads 662 can be adhesive or Velcro material, for example.

The attachment pads 662 can be adhesively secured onto the front face of the platform 661 of the removable platform assembly 660. The attachment pads 662 can be secured within recesses in the removable platform assembly 660. The attachment pads 662 can be any suitable mechanical arrangement or mechanism to attach to a phone, tablet or other object that is desired to be supported upon the removable platform assembly 660. The attachment pads 662 can be foam pads with a peel away film that exposes an adhesive surface. The adhesive surface can adhere to the back surface of the cell phone or tablet. Also a supported tablet or phone can be provided with adhesive pads. The disclosure is not limited to adhesive pads. Other mechanisms can be used to support an electronic tablet or other device or object upon the removable platform assembly 660. For example, Velcro or hook and loop fasteners, e.g. in combination with an adhesive backing, can be utilized. Also, a magnet can be utilized that can interact with metal or a magnet on the tablet or other device or object to be supported. A user can manipulate an attached phone or tablet in any of a wide variety of ways. The user can rotate the tablet by rotating the removable platform assembly 660 upon the stand assembly 50.

As shown in FIG. 40, the removable platform assembly 660 can include or be connected to a slide desk 670. The slide desk 670 can be slidable into and out of the removable platform assembly 660.

Accordingly, the slide desk 670 can be slid from an extended position, as shown in FIG. 40, to a retracted position. In the retracted position, the slide desk 670 is “tucked” or slid into the removable platform assembly 660.

The slide desk 670 can include a note cavity 671. The note cavity 671 can hold or house a pad of paper. For example, a pad of paper can have adhesive backing and be adhesively positioned in the note cavity 671. Also, the slide desk 670 can include one or more pad retaining flanges 671F that extend over or across one or more corners of the note cavity 671, as shown in FIG. 40. The pad retaining flanges 671F can be small segments of molded plastic that extend or bridge over a corner of the note cavity. A pad of paper can be tucked underneath the pad retaining flanges. Accordingly, the pad retaining flange 671F can help to retain a pad of paper or sheets of paper in the note cavity 671. An access groove 672 can be provided. The access groove 672 can be a groove or recess that allows a user to insert her finger underneath paper or a pad of paper in the note cavity 671.

As shown in FIG. 40, the slide desk 670 also includes a stylus clip 673. The stylus clip or stylus retainer 673 can retain a stylus or pen 699. Any stylus, pen or pencil can be retained, as desired, so long as it is receivable within the stylus clip 673.

The slide desk 670 can include a hole or aperture 674. The hole 674 can support a strap, clip, or other device to support and/or provide manipulation assistance. The hole 674 can also be grabbed by a user—to assist the user in manipulating the slide desk 670 between a stowed position and an extended position. Further details regarding the slidable arrangement of the slide desk 670 are described below.

The removable platform assembly 660 can also include or be associated with a handle 680. The handle 680 can include a grip portion 681. The handle 680 can include an upper connection portion 682 that is connected to an extension portion 683. The extension portion 683 can extend upwards from the removable platform assembly 660. The extension portion 683 can include an upper handle aperture 684. The aperture 684 can be to attach a strap or clip or for other manipulation. The handle 680 can also include a lower connection portion 685. The lower connection portion 685 can include a lower handle aperture 686. The lower handle aperture 686 can be to attach a strap or clip or for other manipulation. The upper connection portion 682 and the lower connection portion 685 can serve to attach the handle to the platform 661. The handle 680 can be integrally formed with the platform 661.

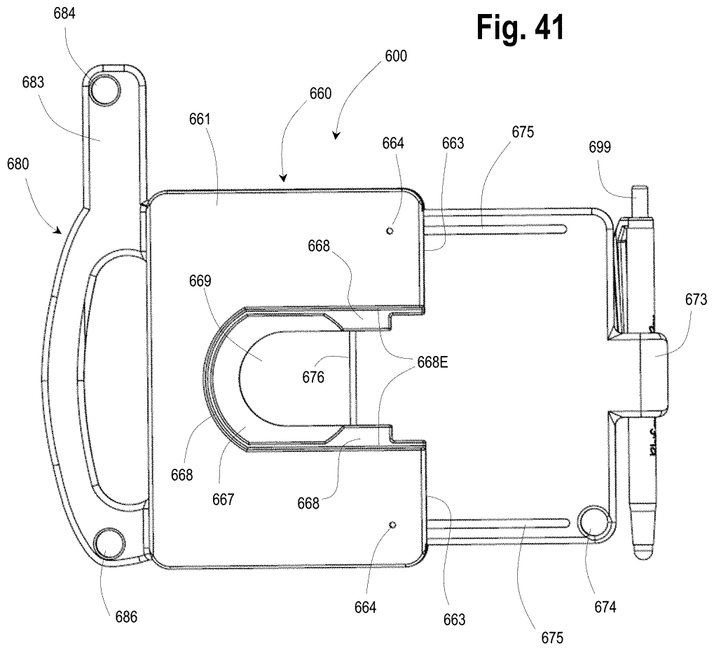

FIG. 41 is a back view of removable platform assembly 660, in accordance with principles of the disclosed subject matter. As described above, the slide desk 670 can be slid from an extended position to a retracted position. In the retracted position, the slide desk 670 is stowed within the removable platform assembly 660. Accordingly, the removable platform assembly 660 can include a cavity 663 within the removable platform assembly 660. In other words, the removable platform assembly 660 can be hollowed out in the form of a slit or cavity that accepts the slide desk 670. FIG. 41 shows what could be the fully extended position of the slide desk 670. An inner edge 676 of the slide desk 670 is visible in FIG. 41.

Various structure can be utilized so as to allow the slide desk 672 to slide smoothly in to an out of the removable platform assembly 660. For example, grooves could be provided on the slide desk 670 and mating ribs provided in the interior of the removable platform assembly 660, or vice versa. Relatedly, the “travel” of the slide desk 670 relative to the removable platform assembly 660 can be controlled, constrained, or limited. Specifically, the slide desk 670 can include pin slots or grooves 675. Travel limiting pins or pins 664 can be secured within the removable platform assembly 660 and pass into a respective groove 675. The structure of such pin can be the same as discussed otherwise herein and shown in FIG. 36, for example. Accordingly, as shown in FIG. 41, each pin 664 can be supported by the removable platform assembly 660 and extend into the groove 675. Thus, sliding motion of the slide desk 670 will be constrained by travel of the pin 664 within the slot 675.

FIG. 41 also shows aspects of the removable platform assembly 660 that allow the removable platform assembly 660 to be mounted upon or slid upon the engagement assembly 640. That is, as shown in FIG. 41, the removable platform assembly 660 can include a ring magnet 667, which can be seated in a recess shaped so as to accommodate the ring magnet. The ring magnet 667 can be of similar structure to the attachment plate 390 that is shown in FIG. 33. The ring magnet 667 can be molded into the removable platform assembly 660. The removable platform assembly 660 can include slide surfaces 668. The slide surfaces 668 can be withdrawn into or recessed into the removable platform assembly 660 relative to the surface 661S of the platform 661. As a result, an edge 668E can wrap around the receiving slot 669. Further, the slide surfaces 668 can be even with or flush with the surface of the ring magnet 667. The ring magnet can wrap around or encircle or form a receiving slot 669. That is, the centering collar 653 can be received into the receiving slot 669. The surface 668 can “wrap around” the receiving slot as shown in FIG. 41. Such arrangement provides for structure to engage with the engagement assembly 640, as described herein.

As described above, the engagement assembly 640 can include guide flanges 643, 645. Relatedly, the removable platform assembly 660 can include grooves on the top and bottom that respectively engage with guide flanges 643, 645. A groove 666 can be provided on a lower edge of the removable platform assembly 660, as shown in FIG. 37. A groove 665 can be provided on an upper edge of the removable platform assembly 660. Accordingly, the groove 665 can engage with the guide flange 643, as the removable platform assembly 660 is slid onto the engagement assembly 640, from the right moving left as shown in FIG. 38. The groove 666 can engage with the guide flange 645 (see FIG. 39), as the removable platform assembly 660 is slid onto the engagement assembly 640, from the right moving left as shown in FIG. 38. Accordingly, the upper and lower edges of the removable platform assembly 660 can be stably positioned and supported upon the engagement assembly 640.

Additional engagement and support can be provided by other structure of the removable platform assembly 660 and the engagement assembly 640. That is, as the removable platform assembly 660 is slid onto the engagement assembly 640, the centering collar 653 is slid into the receiving slot 669. The centering collar 653 can be constructed of metal or magnetic material. Also, the ring magnet 667 can be constructed of metal or magnetic material. Accordingly, the centering collar 653 can be slid into and attracted to the ring magnet 667 so as to afford further support of the removable platform assembly 660 on the engagement assembly 640. Additionally, the flats 654F can provide support. Specifically, the flats 654F can be slid between and nested up against the edges 668E (see FIG. 41). As shown in FIG. 39 and FIG. 41, the shape of the raised portion 654 can be matching to the shape of the edge 668E. Accordingly, as the removable platform assembly 660 is slid fully onto the engagement assembly 640, the edge of the raised portion 654 can match up with the edge 668E so as to afford stable support.

It is appreciated that in some embodiments, the top receiving shoulder 642 and the bottom receiving shoulder 644 can be omitted. That is, the removable platform assembly 660 with slide desk 670 could be supported by the centering collar 653 and the raised portion 654, as well as surrounding structure. The ring magnet 667 can be magnetically attached and attracted to the centering collar 653 so as to maintain the removable platform assembly 660 in position upon the engagement assembly 640.

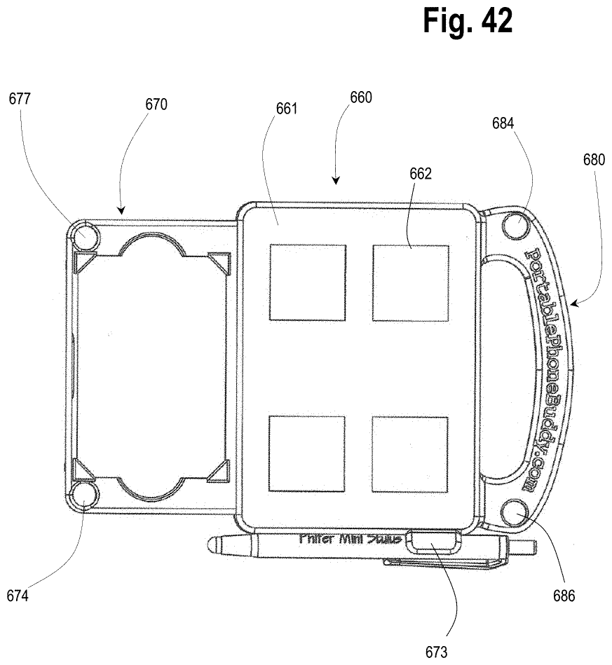

FIG. 42 is a top view of a removable platform assembly 660, in accordance with principles of the disclosed subject matter. The removable platform assembly 660 of FIG. 42 is similar to the removable platform assembly 660 shown in FIG. 40. However, the removable platform assembly 660 shown in FIG. 42 can include slight variations. Specifically, the extension portion 683 can be omitted, and a upper handle aperture 684 provided on the upper right corner of the removable platform assembly 660. The aperture or hole 684 in conjunction with the hole 686 can be beneficial in supporting a strap or other carrying mechanism. Also, the arrangement of FIG. 42 can include a stylus clip 673 that can be supported upon or integrally formed with the removable platform assembly 660. The stylus clip 673 can support a stylus, pencil or pen, for example. Accordingly, in the embodiment of FIG. 42 the stylus clip 673 is disposed on the removable platform assembly 660. In contrast, in the embodiment of FIG. 40, the stylus clip 673 is disposed on the slide desk 670.

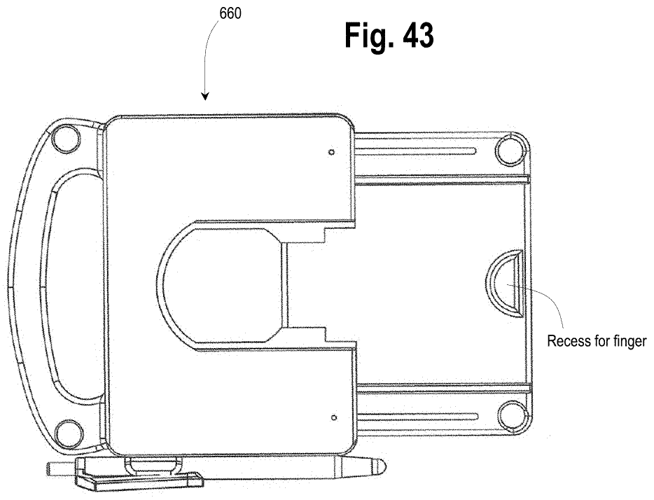

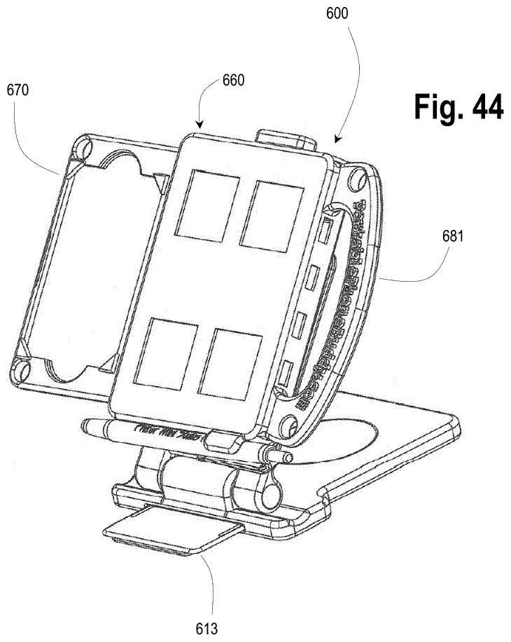

In further illustration of the embodiment of FIG. 42, FIG. 43 is a back view of the removable platform assembly 660, in accordance with principles of the disclosed subject matter. Also, FIG. 44 is a perspective view of a support device 600, in accordance with principles of the disclosed subject matter. The support device 600 of FIG. 44 can include the removable platform assembly 660 of FIGS. 42 and 43. In the arrangement of FIG. 44, the slide desk 670 is in the extended position. Also, the sliding prop member 613 is extended so as to provide stability to the support device 600.

The support device 600 can support a wide variety of electronic devices and objects. The support device 600 can support a smart phone or cell phone, a tablet, or other electronic device. The support device 600 can support an electronic device while providing various manipulation and positioning of the electronic device. As otherwise described herein, the engagement assembly 640 and removable platform assembly 660 can rotate as a unit so as to afford the rotational adjustability. Accordingly, a user device can be switched between landscape and portrait viewing easily. The handle 681 can enhance manipulation of the support device 600 and can provide ease of carrying. Various other advantages are provided.

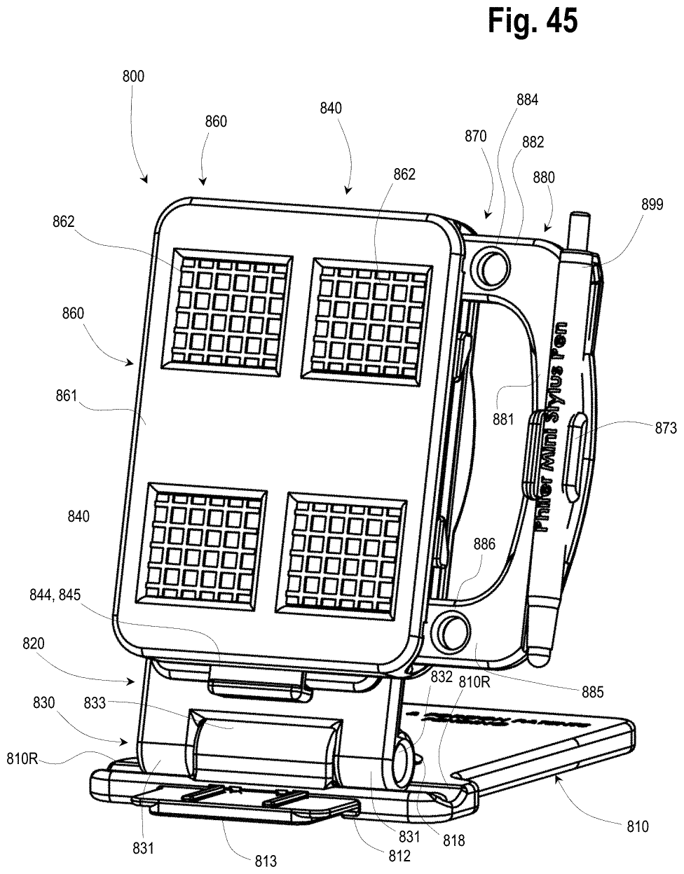

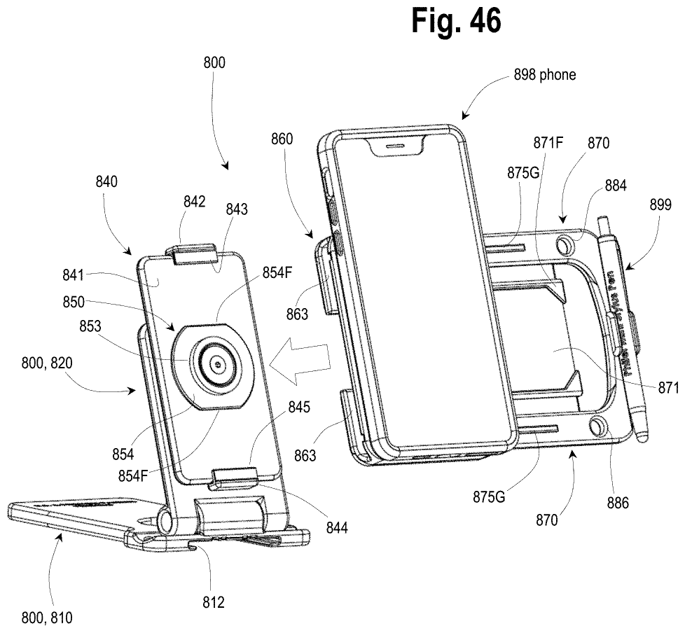

FIG. 45 is a perspective view showing a support device 800, in accordance with a further embodiment of the disclosure, in accordance with principles of the disclosed subject matter. FIG. 46 is a top perspective view of the support device of FIG. 45 showing a sliding relationship between the engagement assembly and the removable platform assembly.

The support device 800 can include a base assembly 810, a stand assembly 820, and an engagement assembly 840. The support device 800 can also include a removable platform assembly 860. The removable platform assembly 860 can be removably mounted onto the engagement assembly 840. The support device 800 can also include a slide desk or desk 870. The slide desk 870 can be slidably supported by the removable platform assembly 860. The slide desk 870 can be positioned in an extended position as shown in FIG. 46 or in a retracted position as shown in FIG. 45. The slide desk 870 can be pushed into or slid into the removable platform assembly 860 such that the slide desk 870 is in a retracted or stowed position. Further details of the manner in which the slide desk 870 is slidably disposed relative to the removable platform assembly 860 are described below.

The base assembly 810 can support the support device 800 on a supporting surface or a supporting structure. The base assembly 810 can have similar features and construct as the base assembly 610 of FIG. 37, and can include a top surface and a bottom surface. The base assembly can include a groove, hinge clearance groove or relief 810R that provides clearance for rotation of the hinge barrels 831. The base assembly 810 can include an attachment element 818. The attachment element 818 can be positioned in a recess as shown in FIG. 45. The attachment element 818 can be integrally formed with the base assembly 810. The attachment element can be a magnet. The attachment element can be a plate or block of metal that can be attracted to a magnet on a supporting surface. The bottom surface of the base assembly 810 can be provided with hook and loop fasteners (Velcro), adhesive tape or other adhesive material, one or more suction cups, and other attachment mechanisms. The base assembly 810 can be provided with any attachment mechanism or other feature as described in other embodiments in this disclosure.

A sliding prop member 813 can be slidably disposed in a prop recess 812. The sliding prop member 813 can be slid from a stowed position to an extended position. In the extended position, the sliding prop member 813 can extend out from the base assembly 810, so as to support the base assembly 810. The sliding prop member 813 can have flanges or ridges on opposing sides so as to engage with structure of the prop recess 812. The sliding prop member 813, the prop recess 812, and related structure can be of similar construct to, and include features of, the sliding prop member 90, the receiving slot 97, and related structure shown in FIGS. 19, 20, 29, 30, 34 and 37, for example. Any feature described herein in the context of one embodiment can be used in other embodiments as desired.

As shown in FIG. 45, the support device 800 can include a hinge assembly 830. The hinge assembly 830 can provide rotatable connection between the stand assembly 820 and the base assembly 810. That is, the hinge assembly 830 can serve to rotatably support the stand assembly 820 upon the base assembly 810.

The hinge assembly 830 can include opposing hinge barrels 831 that are connected to or integrally formed with the stand assembly 820. The hinge assembly 830 can also include a center hinge barrel 833. The center hinge barrel 833 can be rotatably supported between the opposing hinge barrels 831 using a hinge pin assembly 832. The hinge pin assembly 832 can be tightened or loosened so as to provide a desired degree of friction between the center hinge barrel 833 and the hinge barrels 831. The hinge assembly 830 can be of similar construct to, and include features of, the hinge assembly 70 shown in FIGS. 19-25 and 37.

As described above, the support device 800 can include an engagement assembly 840. FIG. 46 is a top perspective view of a support device 800 showing a sliding relationship between the engagement assembly 840 and the removable platform assembly 860. With reference to FIG. 46, the engagement assembly 840 can be rotatably mounted on the stand assembly 820. The engagement assembly 840 can include a body or body portion 841. The engagement assembly 840 can include a second rotation assembly 850. The second rotation assembly 850 can rotatably engage with a first rotation assembly (not shown in FIG. 46) of the stand assembly 820.

As shown in FIG. 21, the stand assembly 50 can rotatably support an engagement assembly 300. That is, in similar manner, the engagement assembly 840 can be rotatably supported on the stand assembly 820. Similar to structure shown in FIG. 24, the stand assembly 820 can include a raised platform or raised center platform 82. The raised platform 82 can be provided with a plurality of spring loaded ball plungers or ball plungers 85. The ball plungers 85 can selectively engage with ball plunger recesses in the engagement assembly 840. Instead of the ball plungers, knobs or protuberances can extend from the stand assembly 820 so as to selectively engage with ball plunger recesses in the engagement assembly 840. The back of the engagement assembly 840 can include a recess, with the with ball plunger recesses, so as to receive and mate with such a raised center platform (with ball plungers) of the stand assembly 820. The engagement assembly 840 can be rotatably attached onto the stand assembly 820 in any manner as otherwise described herein, such as the rotatable attachment arrangements as shown and described with reference to FIGS. 2, 5, 8, 10, 21-26, and 39, for example.

As shown in FIG. 46, the engagement assembly 840 can also include a centering collar 853. The engagement assembly 840 can also include a raised portion 854. The raised portion 854 can be a plateau type structure that surrounds the centering collar 853. The raised portion 854 can include “flats” 854F on the top and bottom of the raised portion 854. The flats 854F can be provided to engage with the removable platform assembly 860.

As shown in FIG. 46, the engagement assembly 840 includes a top receiving shoulder 842 with guide flange 843, as well as bottom receiving shoulder 844 with guide flange 845. The engagement assembly 840 includes the body portion 841 that extends between the top receiving shoulder 842 and the bottom receiving shoulder 844. The receiving shoulders 842, 844 provide slidable engagement to the removable platform assembly 860 as described herein.

FIGS. 45 and 46 also show a perspective view of the removable platform assembly 860, in accordance with principles of the disclosed subject matter. The removable platform assembly 860 can include a platform 861. The platform 861 can include attachment pieces or attachment pads 862. The attachment pads 862 can be adhesive or Velcro material, for example.

The attachment pads 862 can be adhesively secured onto the front face of the platform 861 of the removable platform assembly 860. The attachment pads 862 can be secured within recesses in the removable platform assembly 860. The attachment pads 862 can be any suitable mechanical arrangement or mechanism to attach to a phone, tablet or other object that is desired to be supported upon or by the removable platform assembly 860. The attachment pads 862 can be foam pads with a peel away film that exposes an adhesive surface. The adhesive surface can adhere to the back surface of the cell phone or tablet. Also a supported tablet or phone can be provided with adhesive pads. The disclosure is not limited to adhesive pads. Other mechanisms can be used to support an electronic tablet or other device or object upon the removable platform assembly 860. For example, Velcro or hook and loop fasteners, e.g.

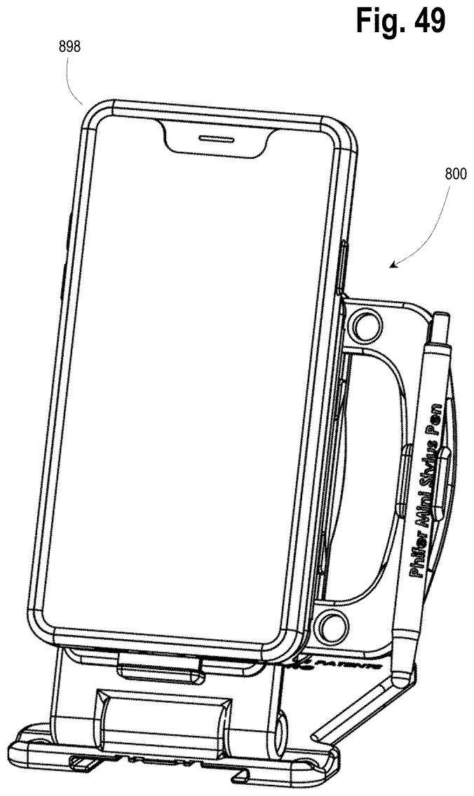

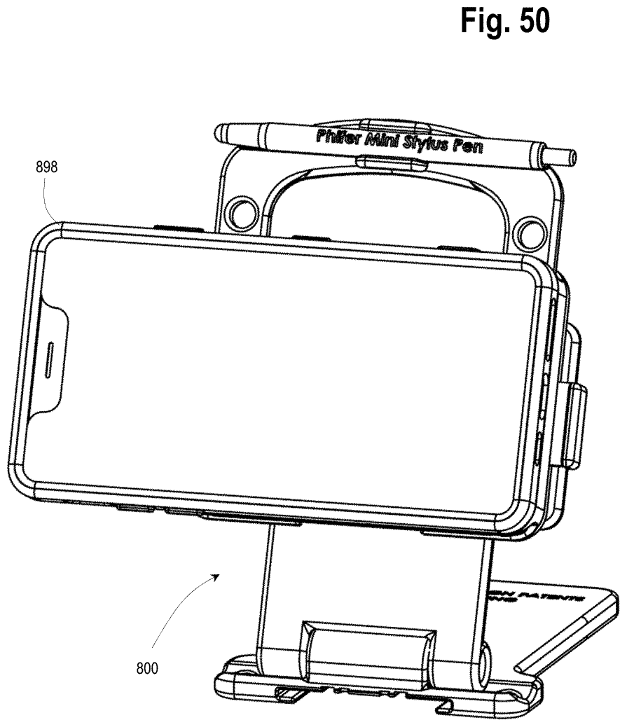

in combination with an adhesive backing, can be utilized. Also, a magnet can be utilized that can interact with metal or a magnet on (or attached to) the phone tablet or other device or object to be supported. A user can manipulate an attached phone or tablet in any of a wide variety of ways. The user can rotate the tablet by rotating the removable platform assembly 860 upon the stand assembly 50, such as is shown in FIGS. 49 and 50, for example.

As shown in FIG. 45 and FIG. 46, the removable platform assembly 860 can include or be connected to a slide desk 870. The slide desk 870 can be slidable into and out of the removable platform assembly 860. Accordingly, the slide desk 870 can be slid from an extended position, as shown in FIG. 46, to a retracted position, as shown in FIG. 45. In the retracted position, the slide desk 870 is “tucked” or slid into the removable platform assembly 860.

The slide desk 870 can include a note cavity 871. The note cavity 871 can hold or house a pad of paper. For example, a pad of paper can have adhesive backing and be adhesively positioned in the note cavity 871. Also, the slide desk 870 can include one or more pad retaining flanges 871F that extend over or across one or more corners of the note cavity 871, as shown in FIG. 46. The pad retaining flanges 871F can be small segments of molded plastic that extend or bridge over a corner of the note cavity. A pad of paper can be tucked underneath the pad retaining flanges. Accordingly, the pad retaining flanges 871F can help to retain a pad of paper or sheets of paper in the note cavity 871.

As shown in FIG. 45, the slide desk 870 also includes a stylus clip 873. The stylus clip or stylus retainer 873 can retain a stylus or pen 899. Any stylus, pen or pencil can be retained, as desired, so long as it is receivable within the stylus clip 873.

The removable platform assembly 860 can also include or be associated with a handle 880. The handle 880 can include a grip portion 881. The handle 880 can include an upper connection portion 882 with aperture or upper handle aperture 884. The handle 880 can also include a lower connection portion 885. The lower connection portion 885 can include a lower handle aperture 886. The lower handle aperture 886 can be attached to a strap or clip or for other manipulation. The upper connection portion 882 and the lower connection portion 885 can serve to attach the handle to the platform 861. The handle 880 can be integrally formed with the platform 861.

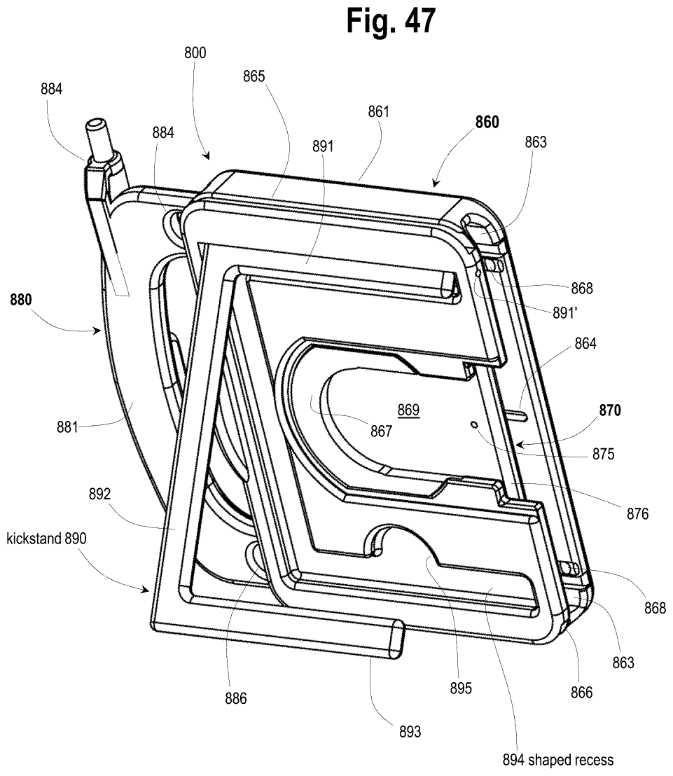

FIG. 47 is a back view of removable platform assembly 860, in accordance with principles of the disclosed subject matter. As described above, the slide desk 870 can be slid from an extended position to a retracted position. In the retracted position, the slide desk 870 is stowed within the removable platform assembly 860. Accordingly, the removable platform assembly 860 can include a cavity 863 within the removable platform assembly 860. In other words, the removable platform assembly 860 can be hollowed out in the form of a slit or cavity that accepts the slide desk 870. FIG. 47 shows an almost fully stowed position of the slide desk 870. An inner edge 876 of the slide desk 870 is visible in FIG. 47. The slide desk 870 can be provided with pin 875, in a pin aperture. The pin can be disposed so as to pass into slot 864, i.e. travel limiting slot 864, in the removable platform assembly 860. Accordingly, similar to other arrangements described herein, the pin 875 engaged with the slot 864 can limit travel of the slide desk relative to the removable platform assembly. The removable platform assembly 860 can also include one of more holes or recesses 868 as shown in FIG. 47. The recesses 868 can be spaced along the width of the removable platform assembly 860, at the top and/or bottom of the cavity 863. The recesses 868 can engage with one or more “domes” or protuberances formed in the slide desk 870—so as to hold the slide desk in a desired position relative to the removable platform assembly 860, and so as to resist movement until the user applies pressure to “click” to another position.

Various structure can be utilized so as to allow the slide desk 872 to slide smoothly in to an out of the removable platform assembly 860. For example, grooves could be provided on the slide desk 870 and mating ribs provided in the interior of the removable platform assembly 860, or vice versa. Relatedly, the “travel” of the slide desk 870 relative to the removable platform assembly 860 can be controlled, constrained, or limited. In addition to the pin 875 and slot, slit or groove 864, the slide desk 870 can include pin slots or grooves 875G, shown in FIG. 46. Travel limiting pins or pins can be secured within the removable platform assembly 860 and pass into a respective groove 875G. The structure of such pin can be the same as discussed otherwise herein and shown in FIG. 36, for example. A pin can be supported by the removable platform assembly 860 and extend into a groove 875G. Thus, sliding motion of the slide desk 870 can be constrained by travel of a pin within a slot 875G.

FIG. 47 also shows aspects of the removable platform assembly 860 that allow the removable platform assembly 860 to be mounted upon or slid upon the engagement assembly 840. That is, as shown in FIG. 47, the removable platform assembly 860 can include a ring magnet 867, which is seated in a recess shaped so as to accommodate the ring magnet. The ring magnet 867 can be of similar structure to the attachment plate 390 that is shown in FIG. 33. The ring magnet 867 and adjacent structure (of FIG. 47) can be of similar structure to the ring magnet 667 and adjacent structure as shown in FIG. 41 and as described above. The ring magnet 867 can be molded into the removable platform assembly 860.

The removable platform assembly 860 can include grooves or slots on the top and bottom that respectively engage with guide flanges 843, 845. A groove 866 can be provided on a lower edge of the removable platform assembly 860, as shown in FIG. 45. A groove 865 can be provided on an upper edge of the removable platform assembly 860. Accordingly, the groove 865 can engage with the guide flange 843, as the removable platform assembly 860 is slid onto the engagement assembly 840, from the right moving left as shown in FIG. 46. The groove 866 can engage with the guide flange 845, as the removable platform assembly 860 is slid onto the engagement assembly 840, from the right moving left as shown in FIG. 46. Accordingly, the upper and lower edges of the removable platform assembly 860 can be stably positioned and supported upon the engagement assembly 840.

Additional engagement and support can be provided by other structure of the removable platform assembly 860 and the engagement assembly 840. That is, as the removable platform assembly 860 is slid onto the engagement assembly 840, the centering collar 853 is slid into a receiving slot 869 formed by the ring magnet 867 and adjacent structure. The centering collar 853 can be constructed of metal or magnetic material. Also, the ring magnet 867 can be constructed of metal or magnetic material. Accordingly, the centering collar 853 can be slid into and attracted to the ring magnet 867 so as to afford further support of the removable platform assembly 860 on the engagement assembly 840. Additionally, the flats 854F can provide support. Specifically, the flats 854F can be slid between and nested up against the edges of the receiving slot 869. As shown in FIG. 46 and in FIG. 47, the shape of the raised portion 854 can be matching to the shape of the edge of the slot 869. Accordingly, as the removable platform assembly 860 is slid fully onto the engagement assembly 840, the edge of the raised portion 854 can match up with the edge of the slot 869 so as to afford stable support.

It is appreciated that in some embodiments, the top receiving shoulder 842 and the bottom receiving shoulder 844 can be omitted. That is, the removable platform assembly 860 with slide desk 870 could be supported by the centering collar 853 and the raised portion 854, as well as surrounding structure. The ring magnet 867 can be magnetically attached and attracted to the centering collar 853 so as to maintain the removable platform assembly 860 in position upon the engagement assembly 840. Other magnetic components can be provided to attract or attach components together.

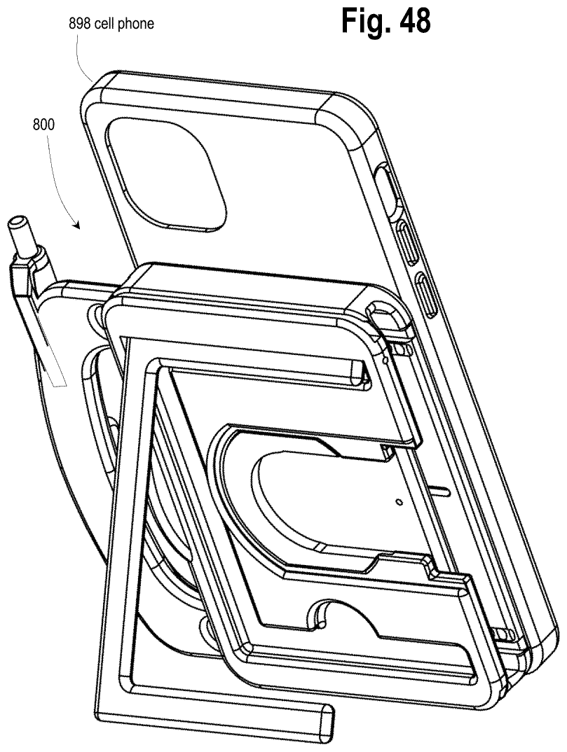

FIG. 47 also shows kickstand 890. The kickstand 890 can include attachment leg 891, extension leg 892 and base leg 893. The kickstand 890 can be pivotally attached to the back of the removable platform assembly 860 by pins. Such a pin can be positioned in a pin aperture 891′. Alternatively, the kickstand 890 can be provided with domes or other protuberances on opposing ends of the attachment leg 891. The surrounding structure of the removable platform assembly 860 can be provided with recesses or holes that respectively receive a protuberance of the kickstand 890, i.e. so as to pivotally support the kickstand as shown in FIG. 48. Relatedly, the removable platform assembly 860 can include the shaped recess 894, which accepts the kickstand 890 therein, i.e. when the kickstand is pivoted into a stowed position. The shaped recess 894 can include a finger pry recess 895. The finger pry recess 895 can be provided for the user to pry, with her finger, the kickstand out from the stowed position. FIG. 48 is a back perspective view of the support device 800 with a phone (user device) positioned upon the support device 800. For example. The support device 800 with a cell phone, as shown, can be supported upon a table top in an angled position, as supported by the kickstand 890. The kickstand 890 can be pivotally attached to the back of the removable platform assembly 860 in any suitable manner

The support device 800 can support a wide variety of electronic devices and objects. The support device 800 can support a smart phone or cell phone, a tablet, or other electronic device. The support device 800 can support an electronic device while providing various manipulation and positioning of the electronic device. As otherwise described herein, the engagement assembly 840 and removable platform assembly 860 can rotate as a unit so as to afford the rotational adjustability. Accordingly, a user device can be switched between landscape and portrait viewing easily. The handle 881 can enhance manipulation of the support device 800 and can provide ease of carrying.

Relatedly, FIG. 49 is a front perspective view of the support device 800 supporting a user device 898 for portrait viewing. The user device can be rotated by rotating the engagement assembly 840 on the stand assembly 820. Accordingly, FIG. 50 is a front perspective view of the support device 800 supporting a user device 898 for landscape viewing. Various other advantages are provided.

It is appreciated that mechanical attachment arrangements as described herein may be switched or flipped as may be desired. That is, for example, a protuberance on a first element that engages with a recess in a second element can be switched so that the protuberance is on the second element and the recess is on the first element. For example, a pin in a first element that engages with a slot in a second element can be switched so that the pin is in the second element and the slot is in the first element. Other mechanical arrangements as described herein can be switched as desired. For example, a male attachment element in a first element that engages with a female attachment element in a second element can be switched so that the male attachment element is in the second element and the female attachment element is in the first element.

It is appreciated that suction cups can be used upon the various components as described herein as may be desired, so as to attach an element to a supporting surface. For example, one or more suction cups can be attached to the base assembly 810 and/or the removable platform assembly 860 so as to attach such components to a supporting surface. Known suction cup structure can be used.

It is appreciated that various embodiments are described herein. It is appreciated that a particular feature of a particular embodiment described herein might be utilized in other embodiments described herein, as desired.

As described above, the device of the disclosure in accordance with the various embodiments may be made from any of a wide variety of materials, as desired. For example, one embodiment of the support device can be made of plastic and/or metal. However, the device of the disclosure, in whole or in part, might be made of any other material, as desired, as described further below.

The support device 10 may be used to support any of a wide variety of personal electronic devices, or other items, and is not limited to those described herein. Accordingly, the support device 10 may be used to support an electronic tablet computer, a cell phone, other telephone, personal digital assistant (PDA), calculator, monitor, remote control unit, or other personal electronic device, or any other item, such as a writing pad, recipe card, document, or book, for example.

The various components of embodiments of the disclosure may be made from any of a variety of materials including, for example, plastic, plastic resin, nylon, metal, composite material, foam, rubber, wood, and/or ceramic, for example, or any other material as may be desired. For example, the device(s) of this disclosure may be produced from a plastic resin, such as polyethylene, and be injection molded. A variety of production techniques may be used to make the apparatuses as described herein. For example, suitable injection molding and other molding techniques and other manufacturing techniques might be utilized. Also, the various components of the apparatuses may be integrally formed, as may be desired, in particular when using molding construction techniques. Also, the various components of the apparatuses may be formed in pieces and connected together in some manner, such as with suitable adhesive and/or heat bonding.

The various apparatuses and components of the apparatuses, as described herein, may be provided in various sizes and/or dimensions, as desired.

It will be appreciated that features, elements and/or characteristics described with respect to one embodiment of the disclosure may be variously used and combined with other embodiments of the disclosure as may be desired.

In this disclosure, quotation marks, such as with “connection portion”, have been used to enhance readability and/or to parse out a term or phrase for clarity.

It will be appreciated that the effects of the present disclosure are not limited to the above-mentioned effects, and other effects, which are not mentioned herein, will be apparent to those in the art from the disclosure and accompanying claims.

Although the preferred embodiments of the present disclosure have been disclosed for illustrative purposes, those skilled in the art will appreciate that various modifications, additions and substitutions are possible, without departing from the scope and spirit of the disclosure and accompanying claims.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present.

It will be understood that when an element or layer is referred to as being “onto” another element or layer, the element or layer can be directly on another element or layer or intervening elements or layers.

Examples include “attached onto”, secured onto”, and “provided onto”. In contrast, when an element is referred to as being “directly onto” another element or layer, there are no intervening elements or layers present. As used herein, “onto” and “on to” have been used interchangeably.

It will be understood that when an element or layer is referred to as being “attached to” another element or layer, the element or layer can be directly attached to the another element or layer or intervening elements or layers. In contrast, when an element is referred to as being “attached directly to” another element or layer, there are no intervening elements or layers present. It will be understood that such relationship also is to be understood with regard to: “secured to” versus “secured directly to”; “provided to” versus “provided directly to”; and similar language.

As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present disclosure.

Spatially relative terms, such as “lower”, “upper”, “top”, “bottom”, “left”, “right” and the like, may be used herein for ease of description to describe the relationship of one element or feature to another element(s) or feature(s) as illustrated in the drawing figures. It will be understood that spatially relative terms are intended to encompass different orientations of structures in use or operation, in addition to the orientation depicted in the drawing figures. For example, if a device in the drawing figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein should be interpreted accordingly.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to diagrams and/or cross-section illustrations, for example, that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of components illustrated herein but are to include deviations in shapes that result, for example, from manufacturing.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, as otherwise noted herein, when a particular feature, structure, or characteristic is described in connection with any embodiment, it is submitted that it is within the purview of one skilled in the art to effect and/or use such feature, structure, or characteristic in connection with other ones of the embodiments.

Embodiments are also intended to include or otherwise cover methods of using and methods of manufacturing any or all of the elements disclosed above.

While the subject matter has been described in detail with reference to exemplary embodiments thereof, it will be apparent to one skilled in the art that various changes can be made, and equivalents employed, without departing from the scope of the disclosure.

All related art references discussed in the above Background section are hereby incorporated by reference in their entirety. All documents referenced herein are hereby incorporated by reference in their entirety.

In conclusion, it will be readily understood by those persons skilled in the art that the present disclosure is susceptible to broad utility and application. Many embodiments and adaptations of the present disclosure other than those herein described, as well as many variations, modifications and equivalent arrangements, will be apparent from or reasonably suggested by the present disclosure and foregoing description thereof, without departing from the substance or scope of the disclosure.

Accordingly, while the present disclosure has been described here in detail in relation to its exemplary embodiments, it is to be understood that this disclosure is only illustrative and exemplary of the present disclosure and is made to provide an enabling disclosure of the disclosure. Accordingly, the foregoing disclosure is not intended to be construed or to limit the present disclosure or otherwise to exclude any other such embodiments, adaptations, variations, modifications and equivalent arrangements.

What is claimed is:

1. A support device for holding an item, the support device comprising:
a base assembly;
a stand assembly pivotally attached to the base by a hinge, and the stand assembly including a first rotation assembly;
an engagement assembly that includes a second rotation assembly, and the second rotation assembly engaged with the first rotation assembly such that the engagement assembly is rotatably attached to and supported on the stand assembly; and
a removable platform assembly that is slidably and removably supported on the engagement assembly, and the removable platform assembly including an attachment element that is configured to attach to a user device.

2. The support device of claim 1, the removable platform assembly including a ring magnet; and
the engagement assembly including a centering collar, and the ring magnet removably engaged with the centering collar.

3. The support device of claim 2, the engagement assembly including a raised portion; and
the removable platform assembly including a slide surface that is surrounded by an edge, and the edge engaged with raised portion.

4. The support device of claim 1, the removable platform assembly including structure to slidably engage and be supported by the engagement assembly.

5. The support device of claim 1, first rotation assembly including a raised center platform, and
the second rotation assembly including a mating attachment recess that is configured to engage with the raised center platform.

6. The support device of claim 5, the engagement assembly including a screw, and the first rotation assembly attached to the second rotation assembly by the screw.

7. The support device of claim 5, the first rotation assembly including a plurality of ball plungers that engage with a plurality of cavities in the second rotation assembly.

8. The support device of claim 1, further including a desk that extends out from the removable platform assembly.

9. The support device of claim 8, the desk is a slide desk that is slidably received into the removable platform assembly.

10. The support device of claim 9, the removable platform assembly including pins that extend into respective slots in the slide desk, so as to constrain sliding movement of the slide desk relative to the removable platform assembly.

11. The support device of claim 9, the slide desk including a note cavity, an access groove to access notes in the note cavity, and a clip to retain a user device, such as a pen or a stylus.

12. The support device of claim 1, the base assembly including a sliding prop member that can slidably be extended out, from a base body portion of the base, so as to support the support device.

13. The support device of claim 1, the support device adapted to hold a cell phone.

14. The support device of claim 1, the removable platform assembly including a body portion and a handle, and the handle extending out from the body portion.

15. The support device of claim 1, the hinge including a hinge barrel that is attached to the base assembly and a pair of opposing hinge barrels that are attached to the stand assembly.

16. The support device of claim 1, the attachment element including a plurality of adhesive pads, and the plurality of adhesive pads for engaging with a user device magnet.

17. The support device of claim 1, the removable platform assembly further including a kickstand, and the kickstand provided to support the removable platform assembly such that the removable platform assembly is positioned at an angle.

18. The support device of claim 18, the kickstand is pivotally attached to a back surface of the removable platform assembly.
